(19) United States
(12) Patent Application Publication
(10) Pub. No.: US 2003/0081685 A1
(43) Pub. Date: May 1, 2003

(54) Method and apparatus for determining patterns within adjacent blocks of data

(76) Inventor: Dennis L. Montgomery, Reno, NV (US)

Correspondence Address: PILLSBURY WINTHROP, LLP, P.O. BOX 10500, MCLEAN, VA, 22102, US

(21) Appl. No.: 09/999,776

(22) Filed: Oct. 31, 2001

(51) Int. Cl. H04N 7/12

(52) U.S. Cl. 375/240.24; 375/240.12

(57) ABSTRACT

The present invention describes methods and apparatus for providing pattern recognition between adjacent sequential frames of data, which data can be non-related data of various types, or related in a time-sequence and contain both audio and image data within each frame. Using a predictive thread to determine a default pattern direction, and then making comparisons between various search blocks from a reference frame with corresponding target search areas of a target frame, in horizontal, vertical, diagonal and rotational directions, using different threads and parallel processing techniques, pattern recognition is achieved, with directional threads that are not obtaining a sufficient number of matches being terminated. Where matches are found, they are stored as a linked list or binary tree, and then processed to so that overlapping matches within a frame are represented as a superset block.

### 1. FIELD OF THE INVENTION

The present invention relates a method and apparatus for determining patterns within adjacent blocks of data.

### 2. BACKGROUND OF THE RELATED ART

Many different techniques exist for the compression of data, and the subsequent decompression of the previously compressed data. ZIP® data compression is one example of a well-known technique that allows for the compression of files and subsequent decompression of previously compressed files.

All compression techniques attempt to reduce the size of a file, or “compress” it, by eliminating redundancies that can exist therein. What will distinguish one compression technique from another is the method that is used to eliminate redundancies. Generally speaking, the more successful a compression technique is in eliminating redundancies, the greater the amount of compression that will occur.

In order to eliminate redundancies, pattern matching of some type is typically employed. It is known, for instance, that in consecutive frames of a movie, that redundant patterns will at times exist. Accordingly, when a movie is digitized into a format, such as MPEG for example, an original sequence of image frames will be replaced a MPEG sequence of I, B and P image frames, which contain a sufficient percentage of the information that exists in the original sequence of image frames for the human eye to accept the reproduction. The MPEG sequence of I, B and P image frames is, however, lossy, since the mathematical representations that are used in obtaining the MPEG sequence of image frames cannot retain all of the data that existed within the original sequence of frames. And redundant patterns exist in many other contexts, on which pattern matching operations can be employed to eliminate redundancies. Sequences of different radiographic images, such as x-rays, will contain redundant patterns. A collection of different executable, or non-executable files, will also contain redundancies between them. It is apparent, therefore, that data of any type can be compared with any other data in an attempt to find patterns that are common to both data sets. Accordingly, in the descriptions that follow, data sets can be obtained and compared with another data set. Each data set that is compared with another data set will be described as being formatted into a frame, that contains therein the data from the data set in a matrix array, that can then be compared to another frame that contains data from another data set. And while the usage of the term frame is easily understood in the context of a related time sequence of images from a movie, each of which will be in a separate frame and constitutes a separate data set, it is understood that the term can be applied to a data set of any type, and thus has a much broader intended applicability and usage than the context of various images from a movie.

Furthermore, there is a large difference between comprehending that redundant patterns exist, and actually finding them. Continuing with the example of a sequence of images from a movie, it is apparent that the digital data with each frame typically be different because of motion in at least part of the image. And that motion can occur in more than one direction at a time. For motion that exists in multiple directions, this can create difficulties with pattern recognition techniques that operate much more efficiently when motion occurs in a single direction, such as MPEG. With adjacent frames that contain more complex motion in the MPEG context, such frames may be required to be a new independent frame, or I frame, rather than B or P types of predictive frames that contain less data. As a result, it is more likely that there will exist a great number of I frames within the corresponding MPEG sequence, and, accordingly, less compression, due to their being less recognition of patterns that do exist, but were not found, between the frames. This occurs due to a combination of many reasons in the MPEG context, but a particularly significant one being that there is only limited motion vector knowledge, and motion vectors, or directions of movement, that are dissimilar to the limited motion vector knowledge that exists are just not found.

Further, the manner in which patterns are determined not only affects the amount of compression that takes place, but the amount of loss that occurs. In MPEG for instance, which is a lossy compression technique, patterns are located using a preset block size, such that in order to achieve compression, a higher amount of loss must be tolerated.

Still further, compression is achieved in techniques like MPEG by representing certain parts of the digital data by a mathematical representation, which representation will typically closely approximate, but in fact differ from, the original. With these techniques, however, while compression is obtained, during the compression process, undesired artifacts can be introduced, which upon subsequent decompression of the data, can cause problems, for instance, degradation in the resulting picture quality. For example, it is well known that in MPEG, that losses of up to and over 20% of the original data content can occur, because of limitations in the DCT algorithm used for compression. And lossless compression techniques, such as LZW, while they do not introduce any loss, typically cannot introduce a significant amount of compression.

Accordingly, it would be desirable to have a pattern matching technique that is both able to operate losslessly, as well as recognize a greater percentage of redundant patterns that exist between adjacent frames of data, when operating in either a lossless mode or in a lossy mode.

### SUMMARY OF THE INVENTION

The present inventions described herein provide advantageous pattern matching techniques.

The present invention describes methods and apparatus for providing pattern recognition between adjacent sequential frames of data, which data can be non-related data of various types, or related in a time-sequence and contain both audio and image data within each frame. Using a predictive thread to determine a default pattern direction, and then making comparisons between various search blocks from a reference frame with corresponding target search areas of a target frame, in horizontal, vertical, diagonal and rotational directions, using different threads and parallel processing techniques, pattern recognition is achieved, with directional threads that are not obtaining a sufficient number of matches being terminated. Where matches are found, they are stored as a linked list or binary tree, and then processed to so that overlapping matches within a frame are represented as a superset block.

In one aspect, the present invention provides a method of compressing a bit-size of a plurality of sequential frames, each frame comprised of a plurality of bits. The method compares a plurality of different search blocks within a reference frame to a target frame to obtain a plurality of compared blocks, the reference frame initially being set to an initial frame of the plurality of sequential frames and the target frame initially being set to a subsequent frame of the plurality of sequential frames. The plurality of compared blocks is used to obtain a representation of the target frame that is compressed. Thereafter, the reference frame is redesignated as the subsequent frame that was the target frame and the target frame is redesignated as another subsequent frame that follows the subsequent frame, with the steps of comparing and using repeated.

In another aspect, there is provided a method of obtaining a linked list of redundant patterns that exist in a target frame from a reference frame, each of the reference and target frames comprised of a plurality of bits. The method comprises the steps of comparing each of a plurality of search block portions of the reference frame to a plurality of locations within the target frame to determine a plurality of matches, and, for each match, representing that portion of the target frame corresponding to the match with a location identifier that is linked to the search block portion.

In another aspect, there is provided a method of searching for patterns within a plurality of sequential frames, each frame comprised of a plurality of bits arranged in a matrix array that can be traversed in horizontal, vertical and diagonal directions. The method comprising comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes traversing the target frame in a horizontal direction to compare at least a first group of search blocks to corresponding horizontal target blocks within the target frame and traversing the target frame in a vertical direction to compare at least a second group of search blocks, which may or may not be different than the first group of search blocks, to corresponding vertical target blocks within the target frame.

In another aspect, the present invention provides a method of searching for patterns within a plurality of sequential frames, each frame comprised of a plurality of bits arranged in a matrix array. The method comprises comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes traversing the target frame in a plurality of different directions to compare search blocks to corresponding target blocks within the target frame, the step of traversing including initiating a plurality of different threads that are processed in parallel, each different thread operating with at least one of a different search block and a different direction; and determining whether the traversals result in a sufficient number of matches being found between the target frame and the reference frame. A step of terminating certain of the plurality different threads then occurs, the step of terminating occurring for a particular thread if it is determined that the traversal related to the particular thread is not resulting in the sufficient number of matches.

In another aspect, the present invention provides a method of compressing a bit-size of a plurality of sequential frames, each frame comprised of a plurality of bits. The method comprises comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing uses a plurality of different threads for comparing, and the search blocks within each of the threads having a uniform size, such that the corresponding compared blocks also have the uniform size. This method uses the plurality of compared blocks to obtain a representation of the target frame that is compressed from an original state. The step of using includes determining whether adjacent compared blocks exist that can be compressed, and for at least certain of the adjacent compared blocks that can be compressed, creating at least one superset block of non-uniform size that includes the certain adjacent compared blocks therein.

In another aspect, the present invention provides a method of searching for patterns within a plurality of sequential frames, each frame comprised of a plurality of bits arranged in a matrix array. The method comprises comparing in a lossy manner a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes obtaining, for a first search block, a first weight indicative of a percentage of comparisons that exist within the target frame and obtaining, for a second search block that overlaps the first search block, a second weight indicative of another percentage of comparisons that exist within the target frame. If the first weight and the second weight both have a percentage of comparisons that exceed a determined threshold, there occurs discarding that compared block of the first and second search blocks that has a lower percentage of comparisons.

In another aspect, the present invention provides a method of searching for patterns within a plurality of sequential frames, each frame comprised of a plurality of bits arranged in a matrix array. The method comprises comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes initiating a predictive thread that compares a number of different predictive search blocks having different block sizes at various positions within the matrix array of the reference frame with various corresponding predictive target blocks in the target frame to obtain a predicted optimum block size and a predicted movement direction for the target frame. The step of comparing also initiates a traversal of the target frame in a direction corresponding to the predicted movement direction with a search block having a size corresponding to the predicted optimum block size.

In another aspect of the present invention, there is provided a method of searching for patterns within a plurality of sequential frames, each frame comprised of a plurality of bits arranged in a matrix array. The method comprises comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes initiating a predictive thread that compares a number of different predictive search blocks having different block sizes at various positions within the matrix array of the reference frame with various corresponding predictive target blocks in the target frame to obtain a predicted optimum block size and a predicted movement direction for the target frame. The step of comparing also includes initiating a traversal of the target frame in a direction corresponding to the predicted movement direction with a search block having a size corresponding to the predicted optimum block size.

In another aspect, the present invention provides a method of searching for patterns within a plurality of sequential frames, each frame comprised of a plurality of bits arranged in a matrix array that can be traversed in at least horizontal and vertical directions. The method comprises comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames. The step of comparing includes traversing the target frame in at least horizontal and vertical directions at increments that are greater than a single bit column or bit row, respectively, to compare search blocks to corresponding target blocks within the target frame. The step of traversing includes, for those search blocks and corresponding target blocks at an edge of the matrix array, padding bit positions within the search blocks and corresponding target blocks that are outside of the reference frame and target frame, respectively, with identical information so that a size of the search block and the corresponding target block can be maintained for the entire step of traversing.

In another aspect of the present invention, there is provided a method of searching for patterns. The method comprises obtaining a plurality of sequential and time-related frames each comprised of a plurality of bits that represent video information and another plurality of bits that represent audio information. Comparing a plurality of different search blocks within a reference frame to a target frame occurs to obtain a plurality of compared blocks, the reference frame initially being set to an initial frame of the plurality of sequential and time-related frames and the target frame initially being set to a subsequent frame of the plurality of sequential and time-related frames. The plurality of compared blocks is used to obtain a representation of the target frame that is compressed.

In another aspect, the present invention provides, a method of compressing a bit-size of a plurality of sequential frames, each frame comprised of a plurality of bits. The method comprises comparing a plurality of different search blocks within a reference frame to a target frame to obtain a plurality of compared blocks, the reference frame initially being set to an initial frame and the target frame initially being set to a subsequent frame. The step of comparing includes determining whether a desired compression ratio between the reference frame and the subsequent frame is reached. If the desired compression ratio is reached, then the step of comparing is terminated. If the desired compression ration is not reached, then the plurality of compared blocks are used to obtain a representation of the target frame that is compressed as compared to an original state.

Other aspects advantages and object of the present invention will become apparent as hereinafter described.

### BRIEF DESCRIPTION OF THE DRAWINGS

The above and other features, and advantages of the present invention, among others, are further described in the detailed description which follows, with reference to the drawings by way of non-limiting exemplary embodiments of the present invention, wherein like reference numerals represent similar parts of the present invention throughout several views and wherein:

FIG. 1 illustrates a block diagram of the present invention.

FIGS. 2A, 2B1, 2B2 and 2C illustrate exemplary digital data formatted into frames according to the present invention.

FIG. 3 illustrates in further detail master blocks within a frame of data and search blocks that operated thereon according to the present invention.

FIG. 4 illustrates an exemplary initial search block within an initial O-frame master block, a corresponding initial search area within a subsequent O-frame master block, and vertical, horizontal and diagonal pattern search directions used according to the present invention.

FIG. 5 illustrates a portion of a subsequent O-frame master block within an exemplary video data stream frame and exemplary search blocks operating thereon.

FIG. 6 illustrates exemplary rotational pattern searching used according to the present invention.

FIGS. 7A-7D illustrate data and headers that are used in obtaining the pattern recognition according to the present invention, and the resulting data format, which resulting data format can then be further compressed.

FIGS. 8A-8C illustrate a flow diagram of the overall operation of the pattern recognition system according to a preferred embodiment of the invention.

FIGS. 9A and 9B illustrate representative a representative search block and a lossy target block, respectively, according to an embodiment of the present invention;

### DETAILED DESCRIPTION OF THE PREFERRED EMBODIMENTS

The present invention provides a pattern matching method that, as a result of providing an indication of the matched patterns, results in compression, but also allows for compression of the data that represents the matched patterns to be further compressed. As was mentioned above, while the present invention can thus be used to operate upon any type of digital data—since any type of digital data can be compared to other digital data—it is of particular significance for applications in which the existence of patterns in data is highly probable, such as a sequence of video images from a digital master of a movie, a sequence of images obtained from a real-time digital camera feed, a sequence of related medical images, a sequence of data representing audio content or redundant data storage devices that are each intended be a copy of the other.

It is also noted that operation of the pattern recognition aspect of the present invention for related sequences, such as video images, preferably operates upon frames of the original digital data that can used to display the image and reproduce the audio. Thus, for instance, a feed from a digital video camera, whether real-time or delayed, or a digital version of a movie can be operated upon. If, however, a previously known compression technique has been used to store the data associated for a sequence, such as MPEG, the present invention will preferably decode the MPEG to obtain a corresponding sequence of frames that most closely correspond to the original master sequence of frames, and operate upon that, although that is not necessary, and the MPEG encoded data can be operated upon in its encoded form, and advantages according to the present invention still derived.

As will become apparent, one reason that the present invention has the ability to operate upon data of any type, whether that data is randomly collected, previously compressed, or previously placed into a known data format, is that the pattern recognition operations are preferably performed at the bit level, comparing bits in one frame of data with bits in another frame of data. Thus, for example, if a search block contains data that represents an image using pixels, and each pixel is represented as 24 bits and is in one frame, if a corresponding search block areas contains pixels that are each identified as having 22 of the 24 bits being the same as in a corresponding pixel in the search block, with only two bits being different, the comparison according to the present invention can determine this degree of similarity, and since at least 22 of every 24 bits is the same, create a linked list, as described hereinafter, that identifies the search area as being the same as the search block, and still achieve considerable compression, and still retain a greater than 90% accuracy.

For data that is related temporally, such as a video or audio, a relationship exists between the various frames. In the context of a movie that contains both video and audio, corresponding to each image in the movie is also that portion of sound that must be synchronized with the movie. While in a system such as MPEG there is an entirely separate compression of the audio that requires a separate audio stream that is separately encoded and decoded, the present invention does not distinguish between the “type” of data that is operated upon, as noted above. Thus, in the present invention, there is no need for a separate stream of audio data when determining whether patterns exist within a frame that contains both audio and video data. The present invention can recognize patterns in both by operating upon both types of data that exist within the same frame. This data can be operated upon without any differentiation therebetween, although, as will be described hereinafter, certain advantages can be obtained by partitioning the audio and video data within a given frame.

The present invention does, however, when working with sequences of frames that contain audio information, most preferably operates, but not necessarily, with audio data that has been translated using the techniques described in U.S. Patent Application entitled “Optical Encoding of Audio Data,” filed by the same inventor on the same day as this application and bearing applicant's attorney reference number 042503/0261933. This other invention describes a technique that converts audio digital data to color-space digital data.

As described in the Optical Encoding application, a digitally sampled audio signal is a sequence of digital values, also referred to as digital audio signal elements, which are spaced apart by the same time interval. Since audio and video data have different formats, audio data is not conventionally appended to video data and encoded with it. The Optical Encoding provides a mechanism for manipulating audio data so that it can be appended to video data for later encoding concurrently with the video data. In particular, a digitally sampled audio signal element is mapped to a color selected from a palette of possible colors. Audio data from various points in time is tracked in time based upon a header (not shown) that indicates the playback rate, which then allows playback of the sequence of digital audio elements at the appropriate time. All of the audio signals that occur at different points in time that have the same amplitude have the same color assigned to them. The process of mapping assigns colors to the corresponding audio data at each different point in time. After the process of mapping, each of the audio signals, instead of having an associated amplitude, has an associated color obtained from a color lookup table. Digital audio signal elements that have the same amplitudes will thus have the same color. And the obtained palette is a sub-palette of the palette of possible colors which can be assigned.

The process for mapping a digitally sampled audio signal element to a color selected from a palette of possible colors in the Optical Encoding application begins by reading the amplitude for a current digital audio signal element. It is then determined whether a color has been previously assigned to the amplitude. If a color has been previously assigned to the amplitude, the previously assigned color lookup for the color is assigned to the current sample. If a color has not been previously assigned to the amplitude, a new color lookup is assigned to both the color and amplitude and the color is added to a sub-palette. The sub-palette is the set of colors that have been assigned to the amplitudes of the digitally sampled audio signal elements. It is then determined whether there are any more digital audio signal elements to process. If there are more digital audio signal elements to process, the process advances to the next sample and the amplitude for the current sample is read in. At the end of process, the sub-palette contains all the colors that were needed to describe the amplitudes at all the times of all of the digitally sampled audio signal elements. Also for each sample, instead of an amplitude there is an associated color from the sub-palette. The output of the process are a frame that contains the sub-palette and the sequence digital audio signal elements in their transformed color format.

After the augmented video frame is decoded, the color audio can be separated from the augmented video frame and the digital audio signal elements recovered as described in the Optical Encoding application. When recovering the digital audio signal elements, the digital color value for the current digital audio signal element is read in and the corresponding digital audio value is retrieved based upon the color lookup. It is then determined whether there are any more digital color values representing the digital audio signal elements to process. If there are more values to process, the process advances to the next sample and the amplitude for the now current sample is read in. The output of process is the original digitally sampled audio signals.

The color space converted audio digital data is preferably organized within a frame in a similar manner for all frames in such frames, with there being a marker, as described further below, that indicates which of the frame blocks within a frame contain this audio data, as will be explained further herein.

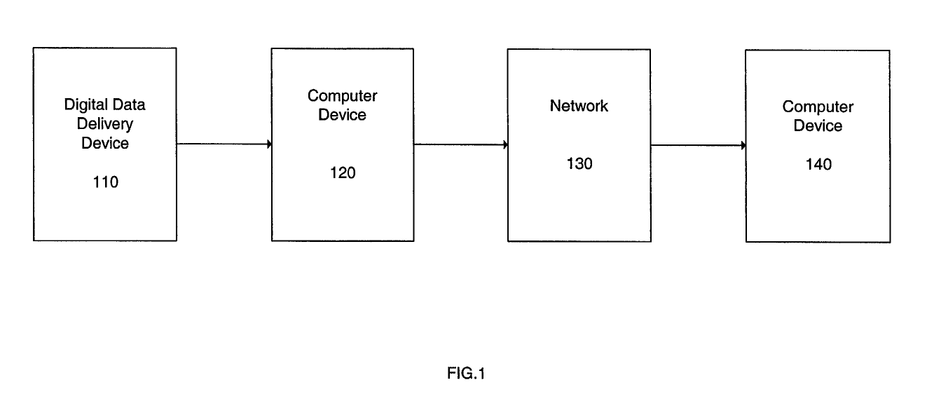

FIG. 1 illustrates an exemplary system 100 according to the present invention, which includes a digital delivery device 110, which could be a digital camera, a hard drive, a disk controller, or any medium that can transmit data of any type in a stream to a downstream device 120. Device 120, as illustrated, is preferably a computer that includes a processor that can perform multi-threaded parallel operations. After pattern recognition is performed using the device 120, subsequent encoding of the stream that contains output data according to the present invention can be performed. Also shown is a network 130, and another device 140, which can perform decoding, as well as re-generate the originally operated upon data, so that the data can then be used as intended. In this regard, the application herein will describe the methods used to obtain pattern recognition according to the present invention. It will be apparent that, once the patterns are recognized, and are correlated using the linked list, binary tree or other data storage formats as described herein, that obtaining the original data from the data formatted as described herein is a simple matter.

While the above system is provided to illustrate one manner in which the advantages of the present invention described herein can be used, this is exemplary. For example, each of the different computer devices 120 and 140 could be implemented as a single computer and devices other than computers that contain processors that are able to implement the inventions described herein can be used instead. Many other variants are possible. And while a device such as mentioned will typically include a processor of some type, such as an Intel Pentium 4 microprocessor or a DSP in conjunction with program instructions that are written based upon the teachings herein, other hardware that implements the present invention can also be used, such as an field programmable gate array. The program instructions are preferably written in C++ or some other computer programming language. For repetitive routines that are used repeatedly, these can be written in assembler for faster processing. As mentioned above, the present invention operates upon data preferably formatted into a matrix array within a frame, as described further hereinafter. For data that is not temporally related, the blocks can be formatted into frames that may or may not have the ability to stored the same amount of data. For data that is temporally related, such as image and audio data, each image and it related audio data will preferably have its own frame, although that is not a necessity.

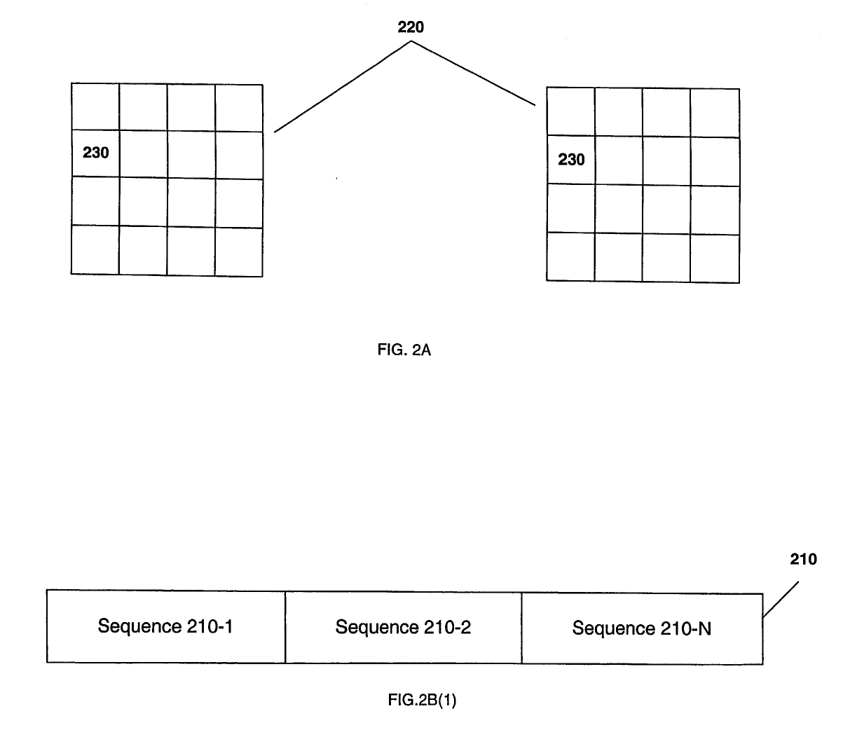

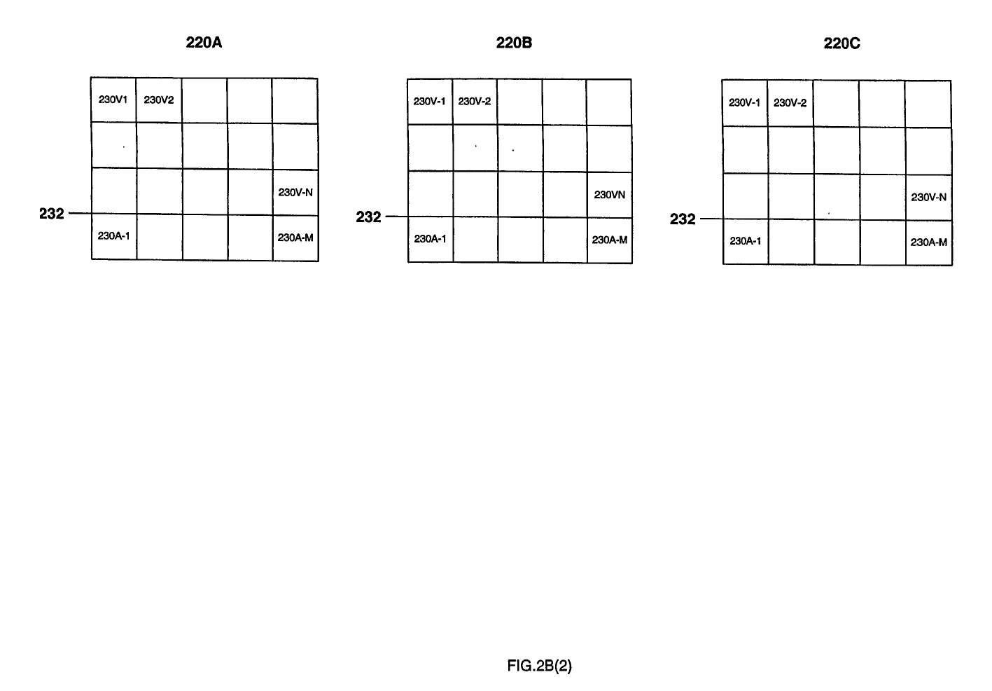

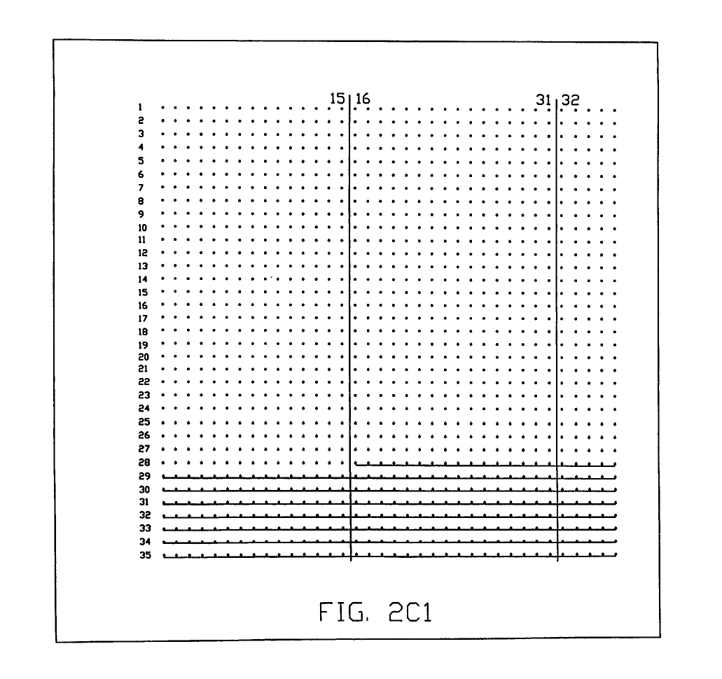

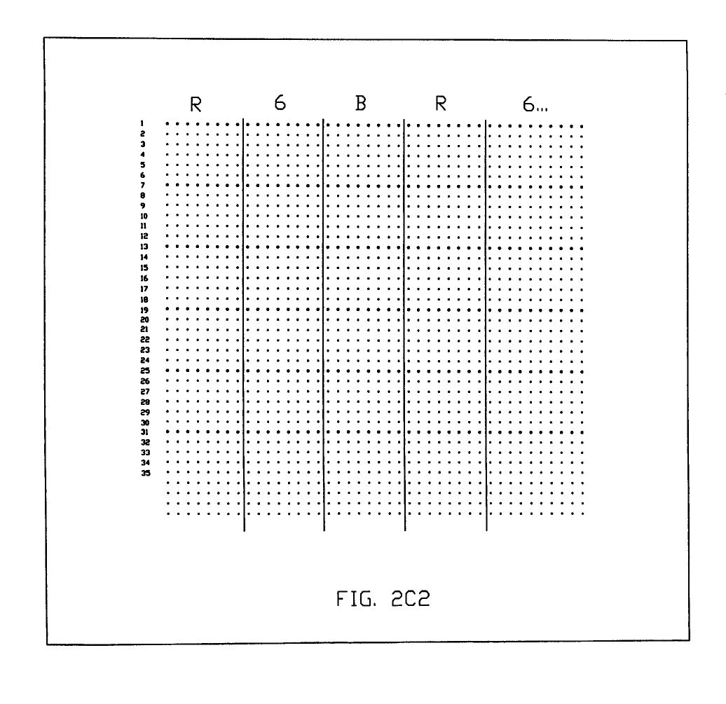

FIG. 2A illustrates representative frames 220, partitioned with frame blocks 230 that contain data that is placed into the frame blocks 230. This data may or may not be temporally related.

FIG. 2B(1) illustrates an example of sequences 210-1, 210-2 . . . 210-n, which could be a digital movie that contains data for each image, which images are temporally related to each other, as well as the corresponding audio data, which temporally relates to the images as well. Each sequence 210 will contain frames 220 that are thus temporally related to each other, as shown by the three frames 220 illustrated in FIG. 2B(2). These frames 220 are shown as having some number of frame blocks 230 (20 for the illustrative purposes herein) of which 15 (230V1, 23V2 . . . 23Vn) are shown as being for video image data, and 5 of which (230A1, 230A2, 230An) are shown as being for audio information. One significant aspect is that the overall matrix array of the frame blocks 230V corresponds to the image that needs to be depicted, with the frame blocks 230A being placed elsewhere, such as at the bottom as shown herein. It is also noted that a marker 232 is placed between the last frame image frame block (shown as 230N) and the first audio frame block (shown as 230A1). This allows, as described further hereinafter, an easy manner in which to identify those frame blocks that contain image and audio information, so that they can be operated upon using different threads, as will be described hereinafter. The marker is a unique combination of bits that will not otherwise appear in the data.

Typically, and preferably in the context of frames that contain temporally related data, each frame will have the ability to store the same amount of data, though that is not a necessity. And within the context of temporally related frames, at least the first frame of a sequence will become what is referred to as a key frame, and, in the case of high movement video, other frames within the sequence may also become key frames, as discussed hereinafter.

FIGS. 2C(1)-(2) illustrate the manner in which data is positioned into a frame block 230. Data for a whole frame is thus partitioned to be placed into frame blocks that typically can each hold the same amount of data.

FIG. 2C1 illustrates a frame block that contains data that is not temporally related. As shown, in this particular example, the data is formed of 16 bit words, and the various words are positioned starting at the upper left hand corner of the frame block 230 and inserted until completed, with each dot in FIG. 2C1 representing a single bit position where storage is available. Illustrated in this Figure is that for bit positions at the end of a frame that do not contain data, illustrated as underlined bit positions, the present invention will preferably pad these positions, as well as any other empty bit positions, with a bit level 0 value.

FIG. 2C2 illustrates a frame block that contains data containing image data, which may be part of a frame that temporally relates to another frame, but may not be as well. As shown, in this particular example, the data is 24 bit RGB data, and thus, 24 bits per pixel. Of course, this data format is provided purely for representative purposes, and other data formats and type of image data are applicable. Data representative of each bit position is preferably placed within the frame block in a position that corresponds to the pixel position of the rendered portion, although other schemes can of course be thought up. Each dot in FIG. 2C2 again represents a single bit position where storage is available.

For a frame block that contains data containing audio data, as mentioned above, this data is preferably converted to a color space, such as RGB data, and can thus be represented in the same manner as the image data, shown in FIG. 2C2. Of course, other data formats can be used. Data representative of each bit position is preferably placed within the frame block in a position that corresponds temporally to the other data representing other portions of the same audio stream, although other schemes can of course be thought up.

Having described the manner in which data that is to be operated is initially positioned within frames, aspects of the present invention that allow for the recognition of patterns that exist between frames will now be described. In particular, before providing a more detailed description of the operation of the pattern recognition system according to the present invention, certain aspects of the searching and pattern recognition strategies, which are individually and together patentably significant, will be discussed. As has been mentioned, the present invention operates upon data at a bit-level. Search blocks of data in a reference frame are each compared with various blocks, as described previously and hereinafter, of the target frame. Matches are preferably determined, at the bit level, although they can also be determined at multi-bit, byte, and multi-byte levels as well. Determining matches is based upon pattern matching operations that compare a representative search block of bits within the reference frame to various positions within the target frame, using a combination of vertical, horizontal, diagonal and rotational search techniques, preferably operating in parallel and using different threads, as described hereinafter.

For purposes of description, the original frames of data will be referred to as original frames, or O-frames, and those frames in which the data needed to represent that frame has been reduced is less in overall size due to patterns being found will be referred to as reduced, or R-frames. Thus, the target O-frame, after pattern matching operations as described herein are performed, will become a reduced or R-frame, since the representation of the data within that frame will, in most instances, be reduced from its original form. If not reduced, it will continue to be an original O-frame, with the data describing that frame identical to the data that existed prior to any of the pattern matching operations taking place. Such an original O-frame that is not reduced is also referred to as a key frame herein. Thus, according to a preferred embodiment of the invention, an initial O-frame is used as a reference frame, from which search blocks are taken and compared with an adjacent target O-frame. The initial O-frame will retain its original data in its original form, and the target O-frame will likely be describable with a reduced data set, or R-frame.

In operation, in a preferred embodiment and as described hereinafter, once the initial reference O-frame completes its pattern matching operations with the target O-frame, although the target O-frame will be represented as an R-frame, the target O-frame, with the original O-frame data, will be used as the new reference O-frame to obtain search blocks that are then taken and compared with the next or adjacent O-frame, which will then become the new target O-frame. By thus detecting patterns that exist within adjacent frames and, in the case of frames with movement the movement direction of patterns that exist within the frames, pattern recognition results, and a linked list can thus be created which reflects these patterns. It is noted, however, that although it in the preferred embodiment the new reference O-frame and the new target O-frame window each other, such that both move, other embodiments can also exists, such as having the initial O-frame remain the reference O-frame, and each of a subsequent plurality of O-frames being consecutive target O-frames, that the same reference O-frame compares to individually.

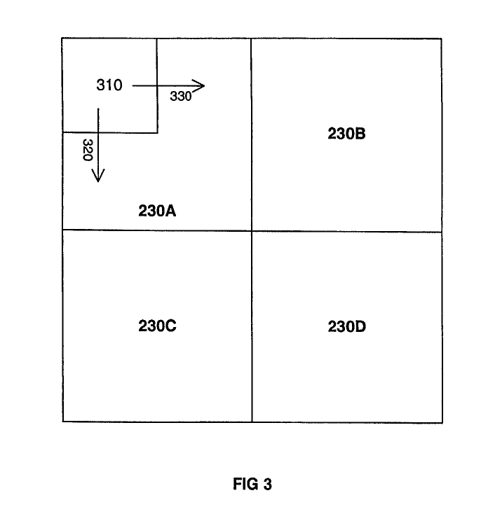

FIG. 3 illustrates in further detail four representative frame blocks 230 within a representative O-frame of data and a representative search block 310 that is defined therein. As discussed previously, of whatever type, is preferably formatted into frames 220 that each contain a matrix array of data. While that data may be unrelated, either temporally or otherwise, and thus formatted into frame blocks of data of any size, frame blocks 230 that have the ability to store an equal amount of data lend themselves more easily to faster processing. In the discussion of the invention that follows, however, a particular example in the context of a video, that contains frames of temporally related data, and various data types within each frame, so that certain of the significant advantages of the present invention can be described and thus understood. Thus, a video will contain a video stream, with sequences of frames. Since the image data and audio data corresponding to the image must be kept together in proper sequence and synchronism, as was mentioned above, a single frame can store both types of data. In such a case, each O-frame will initially have a size that corresponds to the combination of the number of bits required to reproduce the visual image and the number of bits required to reproduce the corresponding audio.

FIG. 3 also illustrates generally that the search block 310 has a smaller size than the frame block 230. While the size of the search block 310 can vary in dependence upon the size of the O-frame, as well as the particular portion of a given frame being operated upon, preferable sizes of search blocks that have been determined to be advantageous for various frame sizes are provided below in Table I.

TABLE I

| Frame type | Search block |
|---|---|
| 320 × 240 bytes video frame | 32 × 32 bytes search block |
| 720 × 480 bytes video frame | 11 4 × 64 bytes search block |
| 1440 × 960 bytes video frame | 128 × 128 bytes search block |
| Audio blocks | 8 × 8 bytes search block |

As will be described further hereinafter, within sequences such as 210A-210D as shown in FIG. 2B1, there will exist frames 220 that will need to be operated upon to determine if there are patterns that exist within the frames 220. To do this, a search block is used. The search block size, once determined, will typically remain the same for frame blocks 230 that contain the same type of data. Thus, while the same search block can be used to search frames that contain frame blocks with both image data and audio data, it has been found advantageous to use a determined search block sizes when searching frame blocks that contain image data, and another determined search block size when searching frame blocks that contain image data. The immediately preceding and subsequent frames, relative to that sequence may be related in time and content, as noted above, but determined to be unrelated, however, for purposes of pattern recognition according to the present invention. For example, a subsequent frame after the sequence of frames may be determined to be a new key frame, since it will not be reduced due to the pattern recognition described herein. Such a new key frame may have a search block of a different size than the sequence of previous frames that were determined to be R-frames, as will become apparent hereinafter, although for data within temporally related frames, this is typically not the case.

FIG. 3 also shows arrows corresponding to the vertical 320 and horizontal 330, directions. This is intended to show that within a given reference O-frame, the search window will be moved across frame blocks 330 so that the entire reference O-frame will have data within each portion used as a search block. As will be described hereinafter, modern processors, which have the ability to operate using multiple threads, are preferably configured so that different threads can simultaneously be processing either different search blocks, or in different directions, as described hereinafter. With respect to the manner in which different search blocks are selected, the search block is preferably moved a single bit position, so that overlapping windows of search blocks exist, although movements of 2, 4, 8 or greater number of bits, as well as byte and multi-byte movements, which provide for less or even no overlap of selected search blocks, can be used. The single bit position movement will thus ensure that all blocks along a same horizontal level are searched, and the search block window can then be independently moved vertically downward, with another set of searches thus taking place along that new horizontal level. Of course, other manners of selecting the order in which search blocks are chosen can be used.

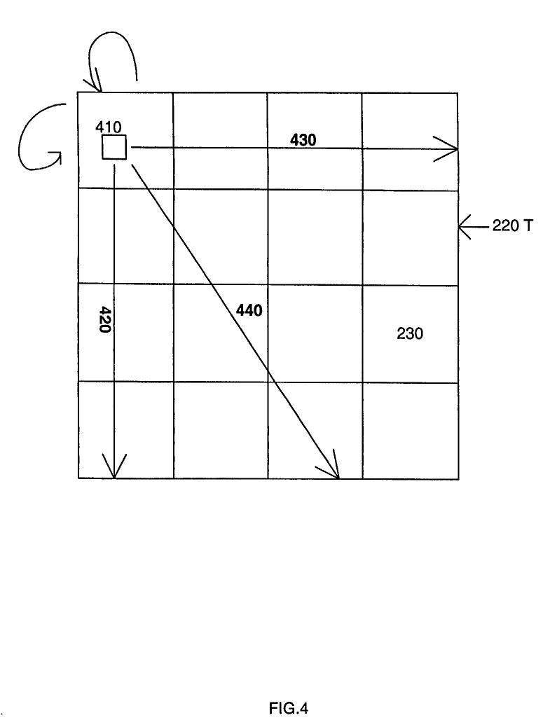

As shown in FIG. 4, when a particular search block 310 from a reference O-frame 220R is applied to a target O-frame 220T, the search block 310 is initially applied at a search block area 410 within the frame block 230T of the target O-frame 220T that corresponds to the same position within the frame block 230R at the same position within the reference R-frame 220R. At this initial position, a binary bit comparison, using an AND operation for lossless compression, and other operations as described further herein for lossy operation, is performed at the bit level between the data that is at that time within the search block 310 and the corresponding data within the search block area 410 of the target O-frame 230T, as described further hereinafter. Once that initial comparison is complete, the search block 310 is then moved in various other movement directions within the frame 220R, including vertical 420, horizontal 430, diagonal 440, and rotational directions, as described herein, and at each such position along a movement direction, another comparison at the bit level of the data within the search window takes place.

FIG. 4 also illustrates preferred vertical movement and horizontal movement directions, and one preferred diagonal movement direction of the search block 410 within a target frame. As shown, starting from the search area 410 of the target frame, the search block 310 then moves down or across for the respective vertical or horizontal movement directions, preferably one bit in the column or row direction at a time for the corresponding vertical and horizontal movement directions, respectively, and for the 45 degree diagonal shown it will preferably move across one bit and down one bit, which can be referred to as a (1,1) diagonal movement. Diagonal movements corresponding to various other angles can be achieved using, for example (1,2), (1,3), (1,4) . . . (1,n) movements, as well as (2, 1), (3, 1), (4, 1) . . . (n, 1) movements. As also shown by the wrap-around arrows, all of the various pixel positions within vertical, horizontal and diagonal directions can be searched, although as described further hereinafter, all such searching may be unnecessary and thus not take place.

When the search window 310 is applied to a search area 410 that is at an edge of a master block, the adjacent master block pixel data is used, and, once at the edge of a frame, the further searching as a result of the wrap around is performed.

At edges, if the movement of the search block window is a single bit, at the edge of the frame 220T, the search window will then go to the opposite side of the frame 220T and begin another comparison. If, however, the search block window jumps multiple bits, at edges of the frame 220T, data will be unavailable to fill the search area 410. In such cases, that data within the search area 410 is padded with zeros, and the corresponding bit positions within the search block 310 are padded with zeros, so that the size of the search block window 310 and the size of the search block area 410 need not change.

FIG. 5 illustrates an exemplary initial search block 310 of a reference O-frame frame block 230R of a reference O-frame 220R applied to an initial search area 410 within a target O-frame frame block 230T. This particular search block 310 is illustrated as a block of 24×24 bits, which size of window is used only for purposes of understanding. The search window 310 is shown at three consecutive horizontal direction search areas, 410, 412, and 414, with the upper left hand bit position, which can be used to identify the search window location on the target O-frame 220, being positions (36,24), (37,24), and (38, 24) respectively. Similar such search areas are obtained for the horizontal direction movements, such as from the (36,24) position to the (36,25) position, and diagonal direction movements, such as the 1-1 movement from the (36,24) position to the (37,25) position.

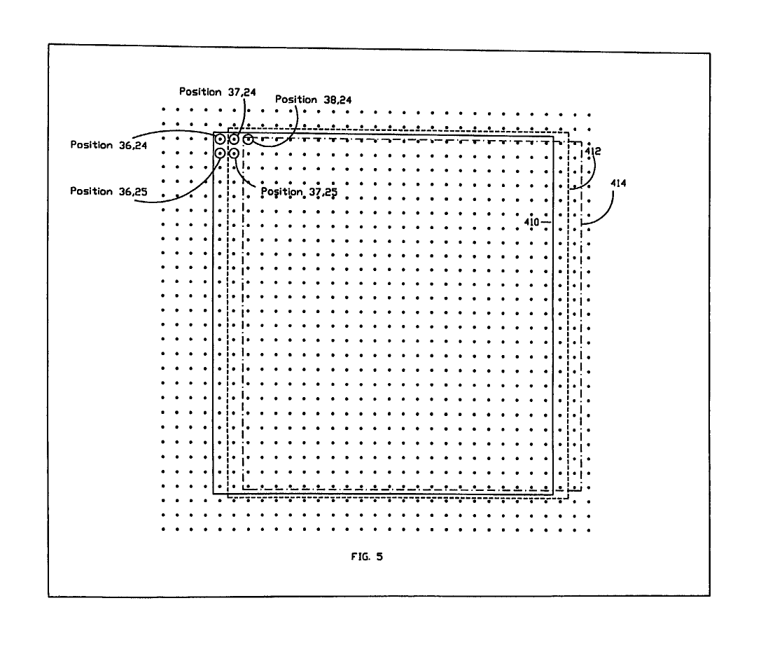

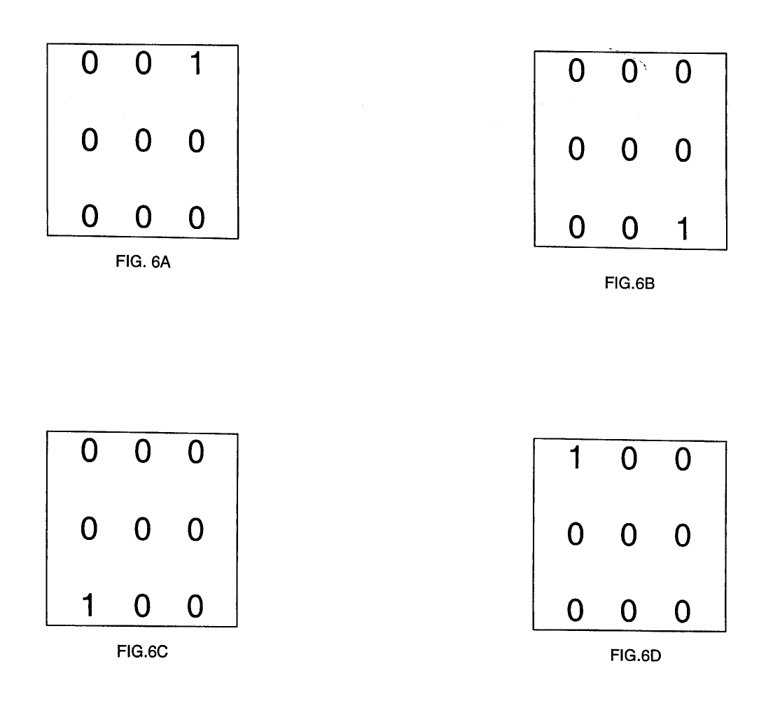

FIGS. 6A-6D illustrates exemplary rotational pattern searching, for a pattern as shown in FIG. 6A, and at the 90, 180 and 270 degree positions, as shown in FIGS. 6B-6D, respectively. The rotational pattern searching based on these principles can be implemented, such that rotations, at different positions obtained using shifting operations as described herein as well, detect rotational shifts in the pattern.

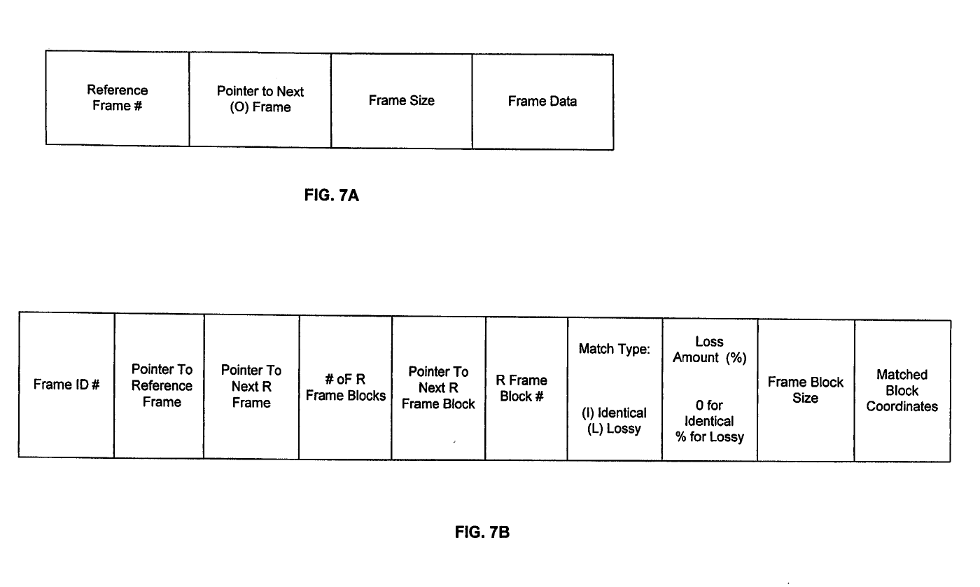

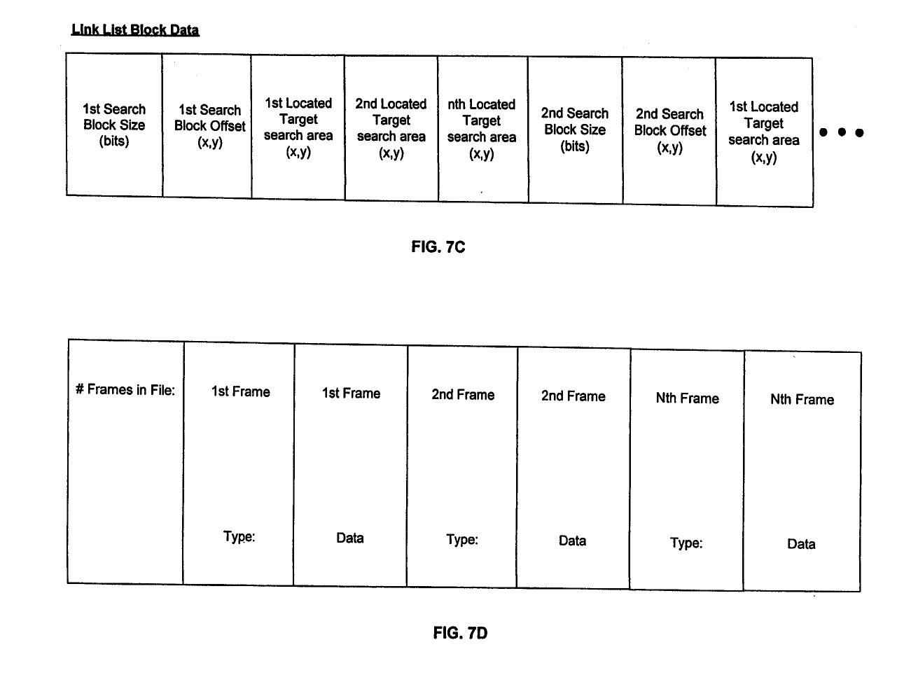

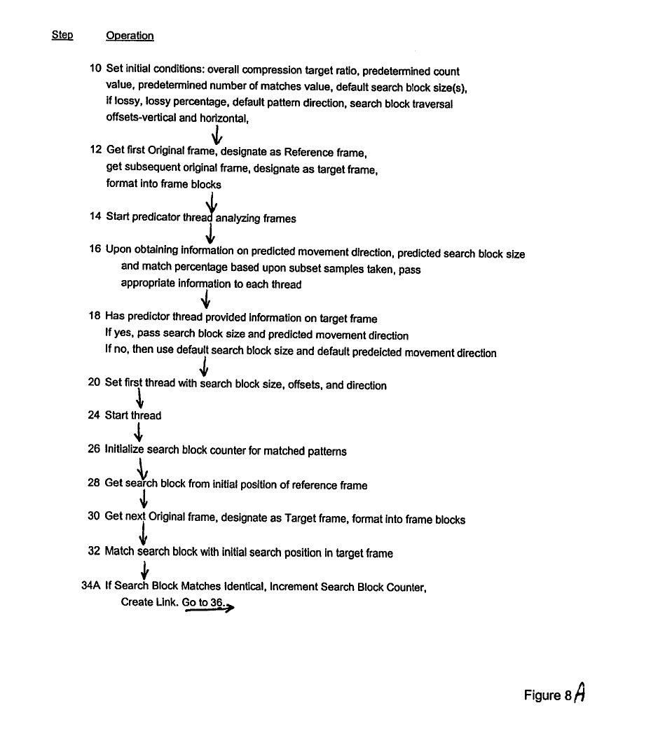

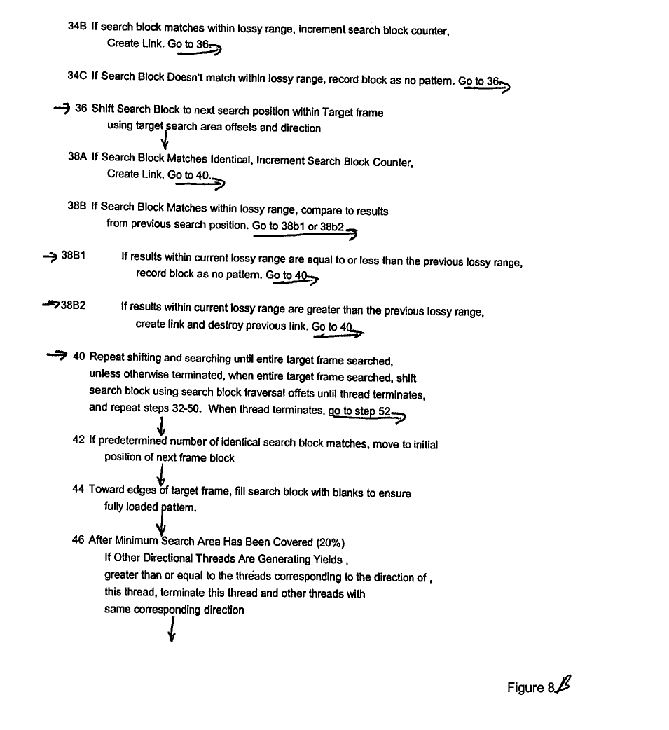

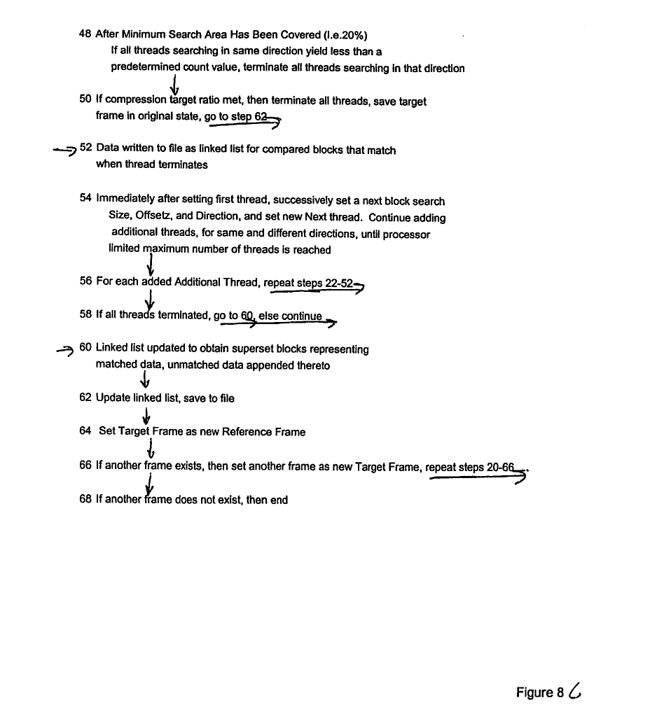

FIGS. 7A-7D illustrate data and headers that are used in obtaining the pattern recognition according to the present invention, and the resulting data format, which resulting data format can then be further compressed. This data and headers will be used when explaining how the invention is implemented to obtain pattern matching, in conjunction with the flowchart of FIGS. 8A-C.

FIGS. 8A-C illustrate a flowchart of a preferred embodiment of the invention. As illustrated in step 10, initial conditions are set. These initial conditions include the overall compression target ratio, a predetermined count value, default search block sizes, a lossy percentage if lossy compression is involved, a default pattern direction, vertical and horizontal search block traversal offsets both and vertical and horizontal target search areas offsets. Each of these will be discussed now in some detail.

The overall compression target ratio is a desired overall compression of the target frame. This overall compression includes that compression obtained by the pattern recognition according to the present invention, but also includes further compression operations that are intended to take place, which further compression operations are outside the scope of the present invention. In certain circumstances, as explained hereinafter, if a larger number of patterns are recognized, the pattern recognition described herein will be stopped and the further compression operations mentioned above are instead used for all compression. For example, in a sequence of frames within a movie, if two adjacent frames contain totally black images (for instance as a precursor to the introductory credits), the overall compression target ratio will be exceeded because these two images are in fact identical.

The predetermined count value is used by the present invention to terminate threads that are shifting search blocks in a particular direction and are not finding matches. In particular, after some minimum search area of the reference block has been searched, for instance 20 percent, it is likely that some matches between the search blocks within that 20 percent area of the reference frame will have found some number of matches within the target frame. Thus, the predetermined count value can be used to set this count. While this count could be set to zero, it could also be set to some higher integer number.

The default search block sizes value provides a value for a default search block size. If within a particular frame more than one search block size is used, for instance one search block size for the frame blocks containing video information and another search block for frame blocks containing audio information, then a commensurate number of search block sizes are defined.

As has been noted here previously, the present invention can be operation in both a lossless mode and a lossy mode. When operating in a lossy mode, the present invention allows the setting of a lossy percentage to determine the amount of loss that can be tolerated within the pattern recognition operations as described herein. Accordingly, the lossy percentage can be set as an initial condition, so that when the search block is making its comparisons upon the search block area of the target frame, a match can be identified if the number of bits within the search block area that are the same reaches the lossy percentage.

The default pattern direction initial condition is set in the direction that will be used to traverse the target frame absent the predictor thread determining that a pattern direction other than the default pattern direction should be used for the first thread.

Search block traversal offsets are also set as an initial condition. It is preferable that a combination of offsets exists for each different type of thread. For instance, a different combination of search block traversal offsets can be used for each different horizontal, vertical, diagonal, and rotational search. Also, different search block traversal offsets can be used when searching different types of information within different frame blocks, such as video information within certain frame blocks and audio information within other frame blocks. The offsets set, with both horizontal and vertical components, will determine the shifting progression within the reference frame that is used to obtain a new search block after the previously used search block has finished its comparisons of the target frame. Various progressions can be used, with the progression preferably including the maximum number of different search blocks, corresponding to each of the various possible positions within the reference frame, such that the likelihood of matches being found with the target frame is increased. Thus, the search block traversal offsets will determine the location within the reference frame of, and thus the contents of, the next search block within the reference frame after the previous search block has performed comparison operations with the target frame. The movement of the search block, based upon the search block traversal offsets, can be bit, multi-bits, a byte, or multi-bytes, as mentioned previously.

The target search area offsets also need to be set in a manner similar to the search block traversal offsets. The target search area traversal offsets determine the amount that a particular search block is moved within the target frame after performing a comparison operation of the search block with a particular search block area at the target frame. Thus, for example, after an initial comparison operation has taken place, using a thread that is operating in a horizontal direction, the horizontal offset will determine the amount that the search block will be shifted within the target frame so that the next comparison operation can take place. That same search block, after having been shifted within the target frame so that all comparison operations at a given row have taken place, will be shifted in a column direction as determined by the column offset. Thereafter, subsequent movements are the search block within the target frame will take place based upon the horizontal offsets as described above. The shifting of the search block, based upon the target search area offsets, can be bit, multi-bits, a byte, or multi-bytes, as mentioned previously.

After having set these initial conditions, operation then follows to step 12, as described hereinafter.

In step 12, if this has not been previously done, the original frames are formatted into frame blocks, and a first frame is designated a reference frame, and a next frame is designated as the target frame.

In step 14, a predictor thread is started that will analyze the original frames. Such original frames, as described previously. When used with the present invention, in addition to the frame data, header information will be added during processing, some of which is maintained and will eventually become encoded, while other header information is temporarily used and then discarded, as will be apparent from the description provided herein. As illustrated in FIG. 7A, in addition to the frame data associated with each frame, a reference frame number or frame ID will be stored so that pointers within other frames can reference this frame, a pointer to where the next frame will be located in memory (i.e. the frame ID of the next frame) and the frame size will be added and associated with the frame data for each frame. The frame data is preferably formatted into a matrix array as previously described. In particular, the predictor thread will make some number of comparisons, such as 20, between the initial reference frame, the subsequent target frame for some limited areas of these frames. In particular, comparisons will take place based upon different portions of the reference frame and operate using different size search blocks. The size of the search blocks can vary considerably, with a range of different sizes that span the range of potential possibilities, from 8×8 bytes to 128×128 bytes and larger, depending upon the size of the frame. In general, the larger the frame, the larger the search block sizes that are used. As a result, the predictor thread can determine a preferred movement direction of an initial search block, a predicted search block size that should be used, and a match percentage indicating whether matches occurred in the comparisons that took place.

Accordingly at step 16, the predictor thread will have analyzed at least a first target frame so that threads relating to comparisons between the initial reference frame and a subsequent target frame can take place. While the predictor thread will continue with other subsequent frames, the search comparison operations will then take place between the initial reference frame and the subsequent target frame. It is understood the predictor thread will continue running in parallel with other threads that are then added, as described hereinafter.

As indicated above, the predictor thread will obtain a predicted movement direction as well as a predicted search block size. These are used to initiate the settings for the first thread that is set for comparisons between the reference frame and the target frame. Furthermore, the predictor thread also obtains a match percentage based upon the search samples that were obtained. Thus, for example, if 20 different samples from the reference frame were matched to the target frame, preferably at locations corresponding to the specific areas of the reference frame and some boundary around those areas (or the entire target frame), a number of predictive matches can be determined. Typically, if that number of predictive matches is low, it is likely that there will not be a large corresponding number of matches between the two frames. In contrast, if that percentage is high, such as 14 out of 20 of the samples matching, than there is a much higher probability there will be many different matching areas between the frames. In this regard, when the data being analyzed in the two frames is a sequence of video information, a low number of predictive matches suggests a high motion sequence, and a high number of predictive matches suggests a low motion sequence. The number or percentage of predictive matches can be used, as described hereinafter, to determine the number of threads to set in a particular movement direction.

Upon completion of step 16, it is determined whether the predictor thread provided information on the predicted movement direction and the predicted search block size for the target frame. If yes, then the predicted search block size and predicted movement direction are passed on to be used by the initial thread that is set. If not, the initial thread that is set, will use the default search block size and a default predicted movement direction. Step 20 follows and the first thread is set, also setting the search block size, vertical and horizontal search block traversal and target search are offsets, and a predicted movement direction for that thread.

Step 24 initiates this first thread, and step 26 follows.

As shown in step 26, a search block counter is initialized. This search block counter is used to detect the number of match instances between a search block and the corresponding search block areas within the target frame that are compared. As the number of comparisons that take place between a search block and a corresponding search block area are known, a ratio of the count from search block counter with respect to the number of comparisons made indicates of the percentage of matches that have been obtained.

After initializing the search block counter in step 26, step 28 follows and a search block is obtained from an initial position of the reference frame. Thereafter, step 32 follows and the search block obtained from the initial search position is compared against the initial search area in the target frame to determine if a match exists using the AND operation for lossless comparisons, and the AND, OR, multiply, divide and other operations for purposes of determining matches if lossy comparisons are being performed, as noted above.

Depending upon the type of comparison that is taking place, as well as whether a match is found, step 34a, 34b, or 34c will follow. In step 34a, if the search block matches identical, indicating that all the bits are the search block were found within the corresponding search block area of the target frame, then the search block counter is incremented, indicating that an identical match took place and a link is created showing the relationship between the search block and the reference frame in the search block area of the target frame. If, however, a lossy comparison operation is permitted, if the search block matches with the lossy range, the search block counter is also incremented as shown by step 34b and a link is created showing the relationship between the search block and the reference frame in the search block area of the target frame. If, however, in step 34c, the search block does not match within the lossy range, then the search block area within the target frame for that particular search block is marked as no pattern. Accordingly, since an insufficient relationship between the search block of the reference frame and the search block area of the target frame was found, this is treated as if there were no match and the comparison process will then continue between that search block and another search block area within the target frame.

To that end, step 36 follows so that the search block can traverse the target frame, and the search block is shifted to the next search position within the target frame. This is done using the target search area offsets that have mentioned previously. Thus, for example, if the initial thread is set to search in a horizontal direction, and the end of a row within a horizontal direction is not reached, then the horizontal target search area offset will be used to move the search block to the next adjacent position within the target frame.

Thereafter, step 38 follows, which step used again, depending upon the type of match that is found and the type of matching operation that is permitted. If, the search block matches identical, then step 38a will increment the search block counter, and create a link showing the relationship between the search block and the reference frame in the search block area of the target frame. If, however, the search block matches within the lossy range and loss is permitted, then the results of this comparison are compared to results from the previous search position as described from either step 38b 1 or 38b2. In step 38b1, if the results within the current lossy range are equal to or less than the previous lossy range obtained from the previous search block area, then this particular search block area is recorded as having no pattern. If, however, the results within the current lossy range are greater than the results from the previous lossy range, then in step 38b2, a link is created, and the previous link is destroyed. Thereafter, whether step 38a, step 38b1 or 38b2 was used, step 40 follows.

In step 40, there is repeat of the shifting and searching steps until the entire target frame is searched, unless otherwise terminated. When the entire target frame has been searched, a new search block is obtained by shifting the search block using the search block traversal offsets, which shifting repeats until the thread terminates. It is also noted that in order to maintain the search block location, a starting position offset that provides the location of the initial position of the search block in the reference frame is used. Further, at the end of a search operation using a particular search block, the next search block is obtained and operated upon using that same thread. An ending position for movement of the search block position within the reference frame, and thus termination of the thread, will be obtained as a result of another thread being created, as described hereinafter.

While the shifting and searching operations take place, it has been recognized that if there is a high number of matches that occur, continuing to search within a frame block, particularly if the offset is a single-bit column or bit row, does not need to be performed. Accordingly, as shown in step 42, if a user preset number of identical matches occur within a given frame block, then the next shift of the search block, instead of being determined by the offsets, will be moved to an initial position of a next frame block within the target frame. If that initial position of the next frame block within the target frame then produces a match, instead of searching further within that particular frame block, the movement can be repeated to the subsequent next frame block within the target block. If matches occur in each first position of each frame block, this indicates, to a high degree certainty, that all of the corresponding bit positions between the initial positions of these adjacent frame blocks will also be matches.

Steps 44 through 50 described hereinafter take place while the shifting and searching operations are taking place. Nonetheless, they are set forth here for ease of discussion, though it is noted that these steps, or other steps discussed herein, need not take place in this described order position.

As set forth, in step 44, if the shift of the target search area in the target frame is at the edges of the target frame and is greater than a single-bit position (since no overlap will occur if the shifting is only a single bit row or single bit column), then the target search area of the target frame will have empty bit positions in those locations corresponding to the locations where the target search area is not filled by the target frame. Accordingly, in such circumstances, the search block is also padded with zeros so that the search block is compared against a corresponding target search area of the same size.

Steps 46, 48 and 50 describe three different types of steps that are used to terminate a particular thread that has been set. As discussed hereinafter, multiple threads with different searches will be running in parallel. In order to terminate certain of the threads that are being unproductive (matches having not been found), steps are used to terminate unproductive threads. As described by step 46, after a minimum search area of the reference frame has been searched, such as 20 percent of the search of the reference frame, if other directional threads are generating yields greater than or equal to the threads corresponding to the direction of this thread, then this particular thread and other threads having a same corresponding directional movement are terminated.

In a somewhat similar type of operation, in step 48, after the minimum search area has been covered, if all threads searching in the same direction yield less than some predetermined count value, which count value could be zero or some number higher as set in the initial conditions as described above, then all threads having this particular search direction are terminated.

Lastly, if the overall compression target ratio as described above with respect to the initial conditions is met, then all the threads including the current thread is terminated. With respect to step 50, if step 50 results, then the target frame is saved in its original state and step 62 described hereinafter follows. As noted above the target frame is saved in its original stated because the pattern matching according the present invention is not needed and subsequent compression routines outside the scope of the present invention can be used.

Once the thread terminates as described by step 40 above, step 52 will follow and data from the thread is written to the file, preferably as a linked list including the compared blocks that match. This is illustrated by FIGS. 7B and 7D that illustrate the reduced frame header, and the link list block data. Each of the identified portions of the data for the reduced frame serve a purpose with respect to these described operations, and, as described above, include information that will be updated and used during the operations described herein. The frame ID is the same as the reference frame number for the Type O frame. The pointer to the next reference or key frame and the pointer to the reduced R frame can be added as those locations are determined, potentially at the conclusion of operations on subsequent frames. The number of reduced frame blocks within the frame can be used for keeping track of operations status. The blocks of data thereafter illustrated in FIGS. 7B and 7C repeat for each frame block within the frame, with those blocks including:

a pointer to the next R-frame block,

an ID or reference number for the R-frame block,

a match type indicating whether lossy or lossless matches are permitted, and if lossy a lossy percentage, which can be beneficial if used to assist in allowing the system to process the steps described herein more quickly,

the frame block size

the matched block coordinates of the target frame, the contents of which are shown in more detail in FIG. 7C, and show both size and location of the search block, as well as the location of the target search area where a match is found. As shown, these coordinates are the linked list with the first, second, and nth located target search area positions, indicating where a match (whether lossy or lossless) has occurred, for that search block within the target frame. This is then repeated for each search block.

Thereafter, just as steps 46, 48 and 50 described terminating threads that had been created, step 54 describes the process of thread creation. In particular, immediately after setting the first thread as has been described above, a next block search size offsets and direction are also determined from the predictive thread as described above and a new thread is set. With respect to setting this new thread, a number of considerations are used. In no preferred order, these include:

that in general a new thread is set spaced apart from the previously set thread in the same direction before setting another thread in a different direction;

that a new thread is set every 100 kilobytes of data for typical data, although for high motion video, a new thread is preferably set every 50 kilobytes of data (the distinction between low motion and high motion video being obtainable from the predictive thread referred to above);

that after setting the threads corresponding to the initial direction that has been searched based upon a predictive thread, the typical default order of searching threads is horizontal, vertical, diagonal and then rotational; and

that the number of threads that are set are essentially processor limited such that the number of threads set are limited by the constraints of the processor being used. Thus, as shown by step 56, for each additional thread, steps 22 to 52 are repeated.

As shown by step 58 with a number of threads having previously been running in parallel, if all the threads are terminated, step 60 then follows. Otherwise, the continuation of the different shifting, searching and thread creation and termination operations and the associated steps as described above continue.

In step 60, the linked list that has been obtained as a result of the compared blocks that were found as matches between the search block of the reference frame and the search block area of the target frame are then updated to obtain superset blocks representing the matched data. In particular, the first, second, and nth located target frame search area positions illustrated in FIG. 7C are collapsed to obtain the superset blocks. Thus, while there may previously have been a number of different relatively small size matched blocks, to the extent that there is an overlap between these small blocks, a large superset block (which need not necessarily have the shape of a block can be found.

In step 62, after having obtained the superset blocks, the data is again updated, preferably in the form of a link list that shows the matches between the reference frame and the target frame which updated data is saved to the file. Thereafter, in step 64 the target frame is set as the reference frame and, in step 66, if another frame exists, then the another frame is set as the new target frame so that steps 20 through 66 can be repeated. Thereafter, as illustrated by step 68 if another frame does not exist, then the end is obtained. Accordingly, a stream of data that includes original frames as well as reduced frames, as indicated in FIG. 7D, will result.

With respect to the above, it is noted that many variations are possible. For example, the order that the steps are implemented can vary. Also, for example, the manner in which the data is tracked at various points in the process can vary, and while a linked list or binary tree is preferably used, other manners of storing the data can be implemented.

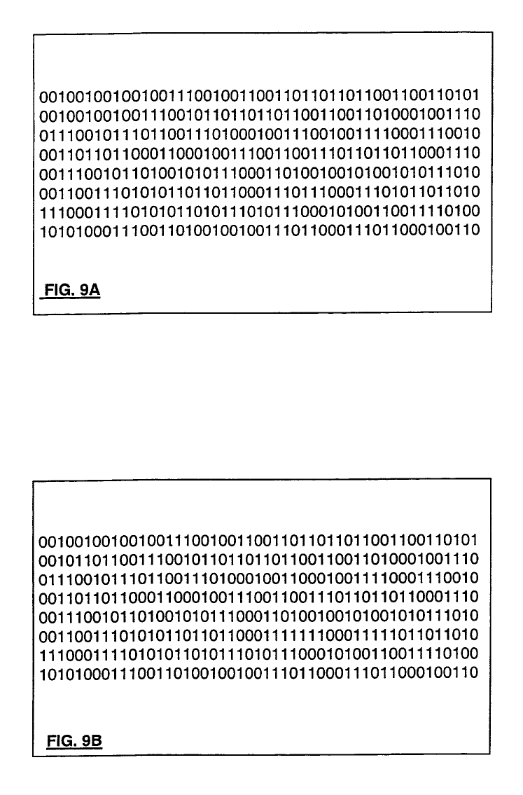

FIG. 9A illustrate an exemplary pattern for a search block, which if losslessly matched will match to a target block that is identical. FIG. 9B illustrates an exemplary target block that fall within the percentage of loss permitted, which is 90% in this example.

The above description described both lossy and lossless pattern recognition techniques, and the comparison between the search block and the search area was performed using an AND operation. While for lossless pattern recognition and AND operation, or its logical equivalent, is needed, for lossless compression, other operations, such as XOR, OR, subtraction, or multiplication, may in fact obtain better results

Referring back to FIG. 1, the above-operations as described can take place within any one of the computers 180, and then the resulting stream be further encoded. Such further encoding can, for instance, use the multiple pass encoding described in U.S. application Ser. No. 09/727,096 entitled “Method And Apparatus For Encoding Information Using Multiple Passes And Decoding In A Single Pass” filed on Nov. 29, 2000, and assigned to the same assignee as the present invention, or other encoding processes. Once fully encoded and then transmitted to a destination device, such as the computer 140 illustrated in FIG. 1, decoding that is the reciprocal of the encoding will be used, and, as the last step of that decoding process, the original set of O-frames can be reproduced from the combination of O-frames and R-frames that result from the usage of the present invention, through usage of the linked list, and pointers as described herein. In light of the detailed description relating to the obtaining of the linked list based upon recognized patterns herein, it will be apparent to one of ordinary skill that obtaining the original data set from this condensed data set can be reproduced by the expansion of the data using the original data that exists within the O-frames that are retained as O-frames.

Although various preferred embodiments have been described in detail above, those skilled in the art will readily appreciate that many modifications of the exemplary embodiment are possible without materially departing from the novel teachings and advantages of this invention.

I claim:

1. A method of compressing a bit-size of a plurality of sequential frames, each frame comprised of a plurality of bits, the method comprising the steps of:
comparing a plurality of different search blocks within a reference frame to a target frame to obtain a plurality of compared blocks, the reference frame initially being set to an initial frame of the plurality of sequential frames and the target frame initially being set to a subsequent frame of the plurality of sequential frames;
using the plurality of compared blocks to obtain a representation of the target frame that is compressed;
redesignating as the reference frame the subsequent frame that was the target frame and redesignating as the target frame another subsequent frame that follows the subsequent frame; and
repeating the steps of comparing and using.

2. The method according to claim 1 further including the steps of repeating the steps of redesignating and repeating so that each of the remaining plurality of sequential frames become the target frame one time while the steps of comparing and using are performed.

3. The method according to claim 1 wherein the representation of the target frame that is compressed uses a linked list.

4. The method according to claim 1 wherein the step of comparing includes the steps of:
traversing the target frame in a horizontal direction to compare each of a first group of the plurality of different search blocks to different positions within the target frame; and
traversing the target frame in a vertical direction to compare each of a second group of the plurality of different search blocks to different positions within the target frame.

5. The method according to claim 4 wherein the step of comparing includes traversing the target frame in a diagonal direction to compare each of a third group of the plurality of different search blocks to different positions within the target frame.

6. The method according to claim 5 wherein the step of comparing further includes the step of traversing the target frame to compare each of a fourth group of the plurality of different search blocks to different positions within the target frame at different rotational positions.

7. The method according to claim 6 wherein the steps of traversing the first group, the second group, the third group and the fourth group are operated on in parallel operations.

8. The method according to claim 7 further including the step of terminating the step of traversing one of the first, second, third and fourth group before terminating the steps of traversing the others of the first, second, third and fourth group.

9. The method according to claim 7 wherein the step of comparing compares search blocks with target blocks within the target frame, and further including the step of terminating specific ones of the search blocks used by the steps of traversing the first, second, third and fourth groups if, after a predetermined portion of the target frame is compared, a predetermined number matches between the one search block and the corresponding target blocks is not reached.

10. The method according to claim 9 wherein the predetermined number is one.

11. The method according to claim 9 wherein the matches are required to be identical matches.

12. The method according to claim 9 wherein the matches can introduce loss.

13. The method according to claim 7 the step of comparing compares search blocks with target blocks within the target frame, and further including the step of terminating specific ones of the search blocks used by the steps of traversing the first, second, third and fourth groups if, after a predetermined portion of the target frame is compared, other ones of the search blocks result in a predetermined greater percentage of matches between the one search block and the corresponding target blocks.

14. The method according to claim 5 wherein the steps of traversing the first group, the second group, the third group are operated on in parallel operations.

15. The method according to claim 14 further including the step of terminating the step of traversing one of the first, second and third group before terminating the steps of traversing the others of the first, second and third group.

16. The method according to claim 14 wherein the step of comparing compares search blocks with target blocks within the target frame, and further including the step of terminating specific ones of the search blocks used by the steps of traversing the first, second and third groups if, after a predetermined portion of the target frame is compared, a predetermined number matches between the one search block and the corresponding target blocks is not reached.

17. The method according to claim 16 wherein the predetermined number is one.

18. The method according to claim 16 wherein the matches are required to be identical matches.

19. The method according to claim 16 wherein the matches can introduce loss.

20. The method according to claim 14 the step of comparing compares search blocks with target blocks within the target frame, and further including the step of terminating specific ones of the search blocks used by the steps of traversing the first, second and third groups if, after a predetermined portion of the target frame is compared, other ones of the search blocks result in a predetermined greater percentage of matches between the one search block and the corresponding target blocks.

21. The method according to claim 4 wherein the steps of traversing the first group and the second group are operated on in parallel operations.

22. The method according to claim 21 further including the step of terminating the step of traversing one of the first and second group before terminating the steps of traversing the others of the first and second group.

23. The method according to claim 21 wherein the step of comparing compares search blocks with target blocks within the target frame, and further including the step of terminating specific ones of the search blocks used by the steps of traversing the first and second groups if, after a predetermined portion of the target frame is compared, a predetermined number matches between the one search block and the corresponding target blocks is not reached.

24. The method according to claim 23 wherein the predetermined number is one.

25. The method according to claim 23 wherein the matches are required to be identical matches.

26. The method according to claim 23 wherein the matches can introduce loss.

27. The method according to claim 21 the step of comparing compares search blocks with target blocks within the target frame, and further including the step of terminating specific ones of the search blocks used by the steps of traversing the first and second groups if, after a predetermined portion of the target frame is compared, other ones of the search blocks result in a predetermined greater percentage of matches between the one search block and the corresponding target blocks.

28. The method according to claim 4 wherein the steps of traversing traverse the target frame such that sequential different positions within the target frame overlap one another.

29. The method according to claim 28 wherein the sequential different positions differ by at most a predetermined number of rows of bits and predetermined number of columns of bits.

30. The method according to claim 29 wherein the predetermined number of rows of bits is one and the predetermined number of column of bits is one.

31. The method according to claim 4 wherein at least one of the steps of traversing the target frame in the horizontal direction and traversing the target frame in the vertical direction traverses the entire target frame.

32. The method according to claim 31 wherein:
traversing the entire target frame in the horizontal direction includes making repeated passes in the horizontal direction at different vertical positions within the target frame; and
traversing the entire target frame in the vertical direction includes making repeated passes in the vertical direction at different horizontal positions within the target frame.

33. The method according to claim 32 wherein adjacent different vertical positions and adjacent different horizontal positions within the target frame differ by at most a predetermined number of rows of bits and predetermined number of columns of bits.

34. The method according to claim 33 wherein the predetermined number of rows of bits is one and the predetermined number of column of bits is one.

35. The method according to claim 32 wherein each of the steps of traversing is implemented using a different processor thread.

36. The method according to claim 35 wherein each of the steps of traversing is implemented using a plurality of different processor threads.

37. The method according to claim 1 wherein at least one video processor thread is used in the step of comparing to compare reference frame video data with target frame video data and at least one audio processor thread is used to compare reference frame audio data with target frame audio data.

38. The method according to claim 1 wherein at least one processor thread is used in the step of comparing to compare reference frame video data with target frame video data and also reference frame audio data with target frame audio data.

39. The method according to claim 1 wherein the step of using obtains the representation of the target frame that is compressed as compared to the original state without any loss being introduced.

40. The method according to claim 1 wherein the step of comparing compares the search block with the target frame using AND operations.

41. The method according to claim 1 wherein the step of using obtains the representation of the target frame that is compressed as compared to the original state with loss being introduced.

42. The method according to claim 41 wherein the step of comparing compares the search block with the target frame using AND operations.

43. The method according to claim 41 wherein the step of comparing compares the search block with the target frame using OR operations.

44. The method according to claim 41 wherein the step of comparing compares the search block with the target frame using XOR operations.

45. The method according to claim 41 wherein the step of comparing compares the search block with the target frame using add operations.

46. The method according to claim 41 wherein the step of comparing compares the search block with the target frame using subtract operations.

47. The method according to claim 41 wherein the step of comparing compares the search block with the target frame using multiply operations.

48. The method according to claim 41 wherein the step of comparing compares the search block with the target frame using divide operations.

49. The method according to claim 1 wherein the step of using combines overlapping ones of the plurality of compared blocks to obtain a superset block that is used for the representation.

50. The method according to claim 1 wherein the step of comparing includes the step of tracking compared blocks that represent an identical match between the search block and a corresponding target block that exists within the target frame.

51. The method according to claim 50 wherein step of tracking is used to provide a dynamic indication of an amount of compression achievable between the reference frame and the target frame and wherein the step of comparing further includes the step of selecting a compression target ratio.

52. The method according to claim 50 wherein the step of comparing is stopped when the dynamic indication indicates that the compression target ratio is reached for the target frame.

53. The method according to claim 52 wherein the step of comparing further includes the step of selecting a desired amount of loss that can be tolerated within the representation.

54. The method according to claim 53 wherein the compared block is considered identical to the search block if a percentage of bits within the target block is at least equal to the desired amount of loss.

55. The method according to claim 1 wherein the step of comparing further includes the step of selecting an amount of loss that can be tolerated within the representation.

56. The method according to claim 1 wherein the step of comparing includes the steps of:
initiating a predictive processor thread to obtain an estimate of a likelihood of matches between the search block and the target frame; and
passing the estimate on to at least one comparing processor thread that is used to compare the plurality of different search blocks within the reference frame to the target frame to obtain the plurality of compared blocks.

57. The method according to claim 1 wherein the step of comparing compares at a bit level.

58. The method according to claim 1 wherein the step of comparing compares at a byte level.

59. A method of obtaining a linked list of redundant patterns that exist in a target frame from a reference frame, each of the reference and target frames comprised of a plurality of bits, the method comprising the steps of:
comparing each of a plurality of search block portions of the reference frame to a plurality of locations within the target frame to determine a plurality of matches; and
for each match, representing that portion of the target frame corresponding to the match with a location identifier that is linked to the search block portion.

60. The method according to claim 59 wherein the step of comparing includes the steps of:
initiating a predictive processor thread to obtain an estimate of a likelihood of matches between the search block and the target frame; and
passing the estimate on to at least one comparing processor thread that is used to compare the plurality of different search blocks within the reference frame to the target frame to obtain the plurality of compared blocks.

61. The method according to claim 59 further including the steps of:
obtaining another target frame;
comparing each of a plurality of search block portions of the reference frame to a plurality of locations within the another target frame to determine a plurality of matches; and
for each match, representing that portion of the another target frame corresponding to the match with a location identifier that is linked to the search block portion.

62. The method according to claim 61 wherein for locations of the target frame that do not match with the search block portions of the reference frame are saved as remaining data that is associated with the target frame.

63. The method according to claim 62 wherein for locations of the another target frame that do not match with the search block portions of the reference frame are saved as remaining data that is associated with the another target frame.

64. The method according to claim 59 wherein the step of comparing compares losslessly.

65. The method according to claim 64 wherein for locations of the target frame that do not match with the search block portions of the reference frame are saved as remaining data that is associated with the target frame.

66. The method according to claim 59 wherein the step of comparing compares with introduction of loss being permitted.

67. The method according to claim 66 wherein for locations of the target frame that do not match with the search block portions of the reference frame within a permitted loss percentage are saved as remaining data that is associated with the target frame.

68. The method according to claim 59 wherein the plurality of locations in the target frame comprise a traversal of an entire target frame and the plurality of search block locations in the reference frame comprise a traversal of an entire reference frame.

69. The method according to claim 59 wherein each frame includes a plurality of bits representative of an image.

70. The method according to claim 69 wherein each frame includes another plurality of bits representative of audio.

71. The method according to claim 59 wherein the step of comparing compares at a bit level.

72. The method according to claim 59 wherein the step of comparing compares at a byte level.

73. The method according to claim 59 wherein the step of comparing includes the steps of:
traversing the target frame in a horizontal direction to compare each of a first group of the plurality of different search blocks to different positions within the target frame; and
traversing the target frame in a vertical direction to compare each of a second group of the plurality of different search blocks to different positions within the target frame.

74. The method according to claim 73 wherein the step of comparing includes traversing the target frame in a diagonal direction to compare each of a third group of the plurality of different search blocks to different positions within the target frame.

75. The method according to claim 74 wherein the steps of traversing the first group, the second group, the third group are operated on in parallel operations.

76. The method according to claim 75 further including the step of terminating the step of traversing one of the first, second and third group before terminating the steps of traversing the others of the first, second and third group.

77. The method according to claim 75 wherein the step of comparing compares search blocks with target blocks within the target frame, and further including the step of terminating specific ones of the search blocks used by the steps of traversing the first, second and third groups if, after a predetermined portion of the target frame is compared, a predetermined number matches between the one search block and the corresponding target blocks is not reached.

78. The method according to claim 77 wherein the predetermined number is one.

79. The method according to claim 77 wherein the matches are required to be identical matches.

80. The method according to claim 77 wherein the matches can introduce loss.

81. The method according to claim 75 the step of comparing compares search blocks with target blocks within the target frame, and further including the step of terminating specific ones of the search blocks used by the steps of traversing the first, second and third groups if, after a predetermined portion of the target frame is compared, other ones of the search blocks result in a predetermined greater percentage of matches between the one search block and the corresponding target blocks.

82. The method according to claim 73 wherein the steps of traversing the first group and the second group are operated on in parallel operations.

83. The method according to claim 82 further including the step of terminating the step of traversing one of the first and second group before terminating the steps of traversing the others of the first and second group.

84. The method according to claim 82 wherein the step of comparing compares search blocks with target blocks within the target frame, and further including the step of terminating specific ones of the search blocks used by the steps of traversing the first and second groups if, after a predetermined portion of the target frame is compared, a predetermined number matches between the one search block and the corresponding target blocks is not reached.

85. The method according to claim 84 wherein the predetermined number is one.

86. The method according to claim 84 wherein the matches are required to be identical matches.

87. The method according to claim 84 wherein the matches can introduce loss.

88. The method according to claim 82 the step of comparing compares search blocks with target blocks within the target frame, and further including the step of terminating specific ones of the search blocks used by the steps of traversing the first and second groups if, after a predetermined portion of the target frame is compared, other ones of the search blocks result in a predetermined greater percentage of matches between the one search block and the corresponding target blocks.

89. The method according to claim 73 wherein the steps of traversing traverse the target frame such that sequential different positions within the target frame overlap one another.

90. The method according to claim 89 wherein the sequential different positions differ by at most a predetermined number of rows of bits and predetermined number of columns of bits.

91. The method according to claim 90 wherein the predetermined number of rows of bits is one and the predetermined number of column of bits is one.

92. The method according to claim 73 wherein at least one of the steps of traversing the target frame in the horizontal direction and traversing the target frame in the vertical direction traverses the entire target frame.

93. The method according to claim 92 wherein:
traversing the entire target frame in the horizontal direction includes making repeated passes in the horizontal direction at different vertical positions within the target frame; and
traversing the entire target frame in the vertical direction includes making repeated passes in the vertical direction at different horizontal positions within the target frame.

94. The method according to claim 93 wherein adjacent different vertical positions and adjacent different horizontal positions within the target frame differ by at most a predetermined number of rows of bits and predetermined number of columns of bits.

95. The method according to claim 94 wherein the predetermined number of rows of bits is one and the predetermined number of column of bits is one.

96. The method according to claim 93 wherein each of the steps of traversing is implemented using a different processor thread.

97. The method according to claim 96 wherein each of the steps of traversing is implemented using a plurality of different processor threads.

98. The method according to claim 59 wherein at least one video processor thread is used in the step of comparing to compare reference frame video data with target frame video data and at least one audio processor thread is used to compare reference frame audio data with target frame audio data.

99. The method according to claim 59 wherein at least one processor thread is used in the step of comparing to compare reference frame video data with target frame video data and also reference frame audio data with target frame audio data.

100. A method of searching for patterns within a plurality of sequential frames, each frame comprised of a plurality of bits arranged in a matrix array that can be traversed in horizontal, vertical and diagonal directions, the method comprising:
comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing including:
traversing the target frame in a horizontal direction to compare at least a first group of search blocks to corresponding horizontal target blocks within the target frame; and
traversing the target frame in a vertical direction to compare at least a second group of search blocks, which may or may not be different than the first group of search blocks, to corresponding vertical target blocks within the target frame.

101. The method according to claim 100 further including the steps of:
determining whether the traversals in the horizontal direction and the vertical direction result in a sufficient number of comparisons being found between the target frame and the reference frame; and
if a sufficient number of comparisons are not determined to exist, traversing the target frame in a diagonal direction to compare at least a third group of search blocks, which may or may not be different than the first and second groups of search blocks, to corresponding diagonal target blocks within the target frame.

102. The method according to claim 100 wherein the step of comparing is repeated on the plurality of sequential frames, and further includes the steps of:
redesignating as the reference frame the subsequent frame that was the target frame and redesignating as the target frame another subsequent frame that follows the subsequent frame; and
repeating the step of comparing.

103. The method according to claim 100 further including the steps of:
redesignating as the target frame another subsequent frame that follows the subsequent frame and;
repeating the steps redesignating and repeating so that each of the remaining plurality of sequential frames become the target frame one time while the step of comparing is performed.

104. The method according to claim 103 wherein the reference frame remains the same.

105. The method according to claim 100 wherein the step of comparing includes traversing the target frame in a diagonal direction to compare each of a third group of the plurality of different search blocks to different positions within the target frame.

106. The method according to claim 105 wherein the step of comparing further includes the step of traversing the target frame to compare each of a fourth group of the plurality of different search blocks to different positions within the target frame at different rotational positions.

107. The method according to claim 106 wherein the steps of traversing the first group, the second group, the third group and the fourth group are operated on in parallel operations.

108. The method according to claim 107 further including the step of terminating the step of traversing one of the first, second, third and fourth group before terminating the steps of traversing the others of the first, second, third and fourth group.

109. The method according to claim 107 wherein the step of comparing compares search blocks with target blocks within the target frame, and further including the step of terminating specific ones of the search blocks used by the steps of traversing the first, second, third and fourth groups if, after a predetermined portion of the target frame is compared, a predetermined number matches between the one search block and the corresponding target blocks is not reached.

110. The method according to claim 109 wherein the predetermined number is one.

111. The method according to claim 109 wherein the matches are required to be identical matches.

112. The method according to claim 109 wherein the matches can introduce loss.

113. The method according to claim 109 the step of comparing compares search blocks with target blocks within the target frame, and further including the step of terminating specific ones of the search blocks used by the steps of traversing the first, second, third and fourth groups if, after a predetermined portion of the target frame is compared, other ones of the search blocks result in a predetermined greater percentage of matches between the one search block and the corresponding target blocks.

114. The method according to claim 105 wherein the steps of traversing the first group, the second group, the third group are operated on in parallel operations.

115. The method according to claim 114 further including the step of terminating the step of traversing one of the first, second and third group before terminating the steps of traversing the others of the first, second and third group.

116. The method according to claim 114 wherein the step of comparing compares search blocks with target blocks within the target frame, and further including the step of terminating specific ones of the search blocks used by the steps of traversing the first, second and third groups if, after a predetermined portion of the target frame is compared, a predetermined number matches between the one search block and the corresponding target blocks is not reached.

117. The method according to claim 116 wherein the predetermined number is one.

118. The method according to claim 116 wherein the matches are required to be identical matches.

119. The method according to claim 116 wherein the matches can introduce loss.

120. The method according to claim 114 the step of comparing compares search blocks with target blocks within the target frame, and further including the step of terminating specific ones of the search blocks used by the steps of traversing the first, second and third groups if, after a predetermined portion of the target frame is compared, other ones of the search blocks result in a predetermined greater percentage of matches between the one search block and the corresponding target blocks.

121. The method according to claim 100 wherein the steps of traversing the first group and the second group are operated on in parallel operations.

122. The method according to claim 121 further including the step of terminating the step of traversing one of the first and second group before terminating the steps of traversing the others of the first and second group.

123. The method according to claim 121 wherein the step of comparing compares search blocks with target blocks within the target frame, and further including the step of terminating specific ones of the search blocks used by the steps of traversing the first and second groups if, after a predetermined portion of the target frame is compared, a predetermined number matches between the one search block and the corresponding target blocks is not reached.

124. The method according to claim 123 wherein the predetermined number is one.

125. The method according to claim 123 wherein the matches are required to be identical matches.

126. The method according to claim 123 wherein the matches can introduce loss.

127. The method according to claim 121 the step of comparing compares search blocks with target blocks within the target frame, and further including the step of terminating specific ones of the search blocks used by the steps of traversing the first and second groups if, after a predetermined portion of the target frame is compared, other ones of the search blocks result in a predetermined greater percentage of matches between the one search block and the corresponding target blocks.

128. The method according to claim 100 wherein the steps of traversing traverse the target frame such that sequential different positions within the target frame overlap one another.

129. The method according to claim 128 wherein the sequential different positions differ by at most a predetermined number of rows of bits and predetermined number of columns of bits.

130. The method according to claim 129 wherein the predetermined number of rows of bits is one and the predetermined number of column of bits is one.

131. The method according to claim 100 wherein at least one of the steps of traversing the target frame in the horizontal direction and traversing the target frame in the vertical direction traverses the entire target frame.

132. The method according to claim 131 wherein:
traversing the entire target frame in the horizontal direction includes making repeated passes in the horizontal direction at different vertical positions within the target frame; and
traversing the entire target frame in the vertical direction includes making repeated passes in the vertical direction at different horizontal positions within the target frame.

133. The method according to claim 132 wherein adjacent different vertical positions and adjacent different horizontal positions within the target frame differ by at most a predetermined number of rows of bits and predetermined number of columns of bits.

134. The method according to claim 133 wherein the predetermined number of rows of bits is one and the predetermined number of column of bits is one.

135. The method according to claim 132 wherein each of the steps of traversing is implemented using a different processor thread.

136. The method according to claim 135 wherein each of the steps of traversing is implemented using a plurality of different processor threads.

137. The method according to claim 100 wherein at least one video processor thread is used in the step of comparing to compare reference frame video data with target frame video data and at least one audio processor thread is used to compare reference frame audio data with target frame audio data.

138. The method according to claim 100 wherein at least one processor thread is used in the step of comparing to compare reference frame video data with target frame video data and also reference frame audio data with target frame audio data.

139. The method according to claim 100 further including the step of using the plurality of compared blocks to obtain a representation of the target frame that is compressed without any loss being introduced.

140. The method according to claim 100 wherein the step of comparing compares the search block with the target frame using AND operations.

141. The method according to claim 100 wherein the step of using obtains the representation of the target frame that is compressed as compared to the original state with loss being introduced.

142. The method according to claim 141 wherein the step of comparing compares the search block with the target frame using AND operations.

143. The method according to claim 141 wherein the step of comparing compares the search block with the target frame using OR operations.

144. The method according to claim 141 wherein the step of comparing compares the search block with the target frame using XOR operations.

145. The method according to claim 141 wherein the step of comparing compares the search block with the target frame using add operations.

146. The method according to claim 141 wherein the step of comparing compares the search block with the target frame using subtract operations.

147. The method according to claim 141 wherein the step of comparing compares the search block with the target frame using multiply operations.

148. The method according to claim 141 wherein the step of comparing compares the search block with the target frame using divide operations.

149. The method according to claim 100 further including the step of using the plurality of compared blocks to obtain a representation of the target frame that is compressed, wherein the step of using combines overlapping ones of the plurality of compared blocks to obtain a superset block that is used for the representation.

150. The method according to claim 100 wherein the step of comparing includes the step of tracking compared blocks that represent an identical match between the search block and a corresponding target block that exists within the target frame.

151. The method according to claim 150 wherein step of tracking is used to provide a dynamic indication of an amount of compression achievable between the reference frame and the target frame and wherein the step of comparing further includes the step of selecting a compression target ratio.

152. The method according to claim 150 wherein the step of comparing is stopped when the dynamic indication indicates that the compression target ratio is reached for the target frame.

153. The method according to claim 152 wherein the step of comparing further includes the step of selecting a desired amount of loss that can be tolerated within the representation.

154. The method according to claim 153 wherein the compared block is considered identical to the search block if a percentage of bits within the target block is at least equal to the desired amount of loss.

155. The method according to claim 100 wherein the step of comparing further includes the step of selecting an amount of loss that can be tolerated within the representation.

156. The method according to claim 100 wherein the step of comparing includes the steps of:
initiating a predictive processor thread to obtain an estimate of a likelihood of matches between the search block and the target frame; and
passing the estimate on to at least one comparing processor thread that is used to compare the plurality of different search blocks within the reference frame to the target frame to obtain the plurality of compared blocks.

157. The method according to claim 100 wherein the step of comparing compares at a bit level.

158. The method according to claim 100 wherein the step of comparing compares at a byte level.

159. A method of searching for patterns within a plurality of sequential frames, each frame comprised of a plurality of bits arranged in a matrix array, the method comprising the steps of:
comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing including:
traversing the target frame in a plurality of different directions to compare search blocks to corresponding target blocks within the target frame, the step of traversing including initiating a plurality of different threads that are processed in parallel, each different thread operating with at least one of a different search block and a different direction; and
determining whether the traversals result in a sufficient number of matches being found between the target frame and the reference frame; and
terminating certain of the plurality different threads, the step of terminating occurring for a particular thread if it is determined that the traversal related to the particular thread is not resulting in the sufficient number of matches.

160. The method according to claim 159 wherein the step of traversing includes the steps of:
traversing the target frame in a horizontal direction to compare each of a first group of the plurality of different search blocks to different positions within the target frame; and
traversing the target frame in a vertical direction to compare each of a second group of the plurality of different search blocks to different positions within the target frame.

161. The method according to claim 160 wherein the step of traversing includes traversing the target frame in a diagonal direction to compare each of a third group of the plurality of different search blocks to different positions within the target frame.

162. The method according to claim 161 wherein the step of traversing further includes the step of traversing the target frame to compare each of a fourth group of the plurality of different search blocks to different positions within the target frame at different rotational positions.

163. The method according to claim 162 wherein the steps of traversing the first group, the second group, the third group and the fourth group are operated on in parallel operations.

164. The method according to claim 163 wherein the step of terminating terminates the step of traversing one of the first, second, third and fourth group before terminating the steps of traversing the others of the first, second, third and fourth group.

165. The method according to claim 163 wherein the step of comparing compares search blocks with target blocks within the target frame, and wherein the step of terminating terminates specific ones of the search blocks used by the steps of traversing the first, second, third and fourth groups if, after a predetermined portion of the target frame is compared, a predetermined number matches between the one search block and the corresponding target blocks is not reached.

166. The method according to claim 165 wherein the predetermined number is one.

167. The method according to claim 165 wherein the matches are required to be identical matches.

168. The method according to claim 165 wherein the matches can introduce loss.

169. The method according to claim 165 the step of comparing compares search blocks with target blocks within the target frame, and wherein the step of terminating terminates specific ones of the search blocks used by the steps of traversing the first, second, third and fourth groups if, after a predetermined portion of the target frame is compared, other ones of the search blocks result in a predetermined greater percentage of matches between the one search block and the corresponding target blocks.

170. The method according to claim 161 wherein the steps of traversing the first group, the second group, the third group are operated on in parallel operations.

171. The method according to claim 170 wherein the step of terminating terminates the step of traversing one of the first, second and third group before terminating the steps of traversing the others of the first, second and third group.

172. The method according to claim 170 wherein the step of comparing compares search blocks with target blocks within the target frame, and wherein the step of terminating terminates specific ones of the search blocks used by the steps of traversing the first, second and third groups if, after a predetermined portion of the target frame is compared, a predetermined number matches between the one search block and the corresponding target blocks is not reached.

173. The method according to claim 172 wherein the predetermined number is one.

174. The method according to claim 172 wherein the matches are required to be identical matches.

175. The method according to claim 172 wherein the matches can introduce loss.

176. The method according to claim 170 the step of comparing compares search blocks with target blocks within the target frame, and wherein the step of terminating terminates specific ones of the search blocks used by the steps of traversing the first, second and third groups if, after a predetermined portion of the target frame is compared, other ones of the search blocks result in a predetermined greater percentage of matches between the one search block and the corresponding target blocks.

177. The method according to claim 160 wherein the steps of traversing the first group and the second group are operated on in parallel operations.

178. The method according to claim 177 wherein the step of terminating terminates the step of traversing one of the first and second group before terminating the steps of traversing the others of the first and second group.

179. The method according to claim 177 wherein the step of comparing compares search blocks with target blocks within the target frame, and wherein the step of terminating terminates specific ones of the search blocks used by the steps of traversing the first and second groups if, after a predetermined portion of the target frame is compared, a predetermined number matches between the one search block and the corresponding target blocks is not reached.

180. The method according to claim 179 wherein the predetermined number is one.

181. The method according to claim 179 wherein the matches are required to be identical matches.

182. The method according to claim 179 wherein the matches can introduce loss.

183. The method according to claim 177 the step of comparing compares search blocks with target blocks within the target frame, and wherein the step of terminating terminates specific ones of the search blocks used by the steps of traversing the first and second groups if, after a predetermined portion of the target frame is compared, other ones of the search blocks result in a predetermined greater percentage of matches between the one search block and the corresponding target blocks.

184. The method according to claim 160 wherein the steps of traversing traverse the target frame such that sequential different positions within the target frame overlap one another.

185. The method according to claim 184 wherein the sequential different positions differ by at most a predetermined number of rows of bits and predetermined number of columns of bits.

186. The method according to claim 185 wherein the predetermined number of rows of bits is one and the predetermined number of column of bits is one.

187. The method according to claim 160 wherein at least one of the steps of traversing the target frame in the horizontal direction and traversing the target frame in the vertical direction traverses the entire target frame.

188. The method according to claim 187 wherein:
traversing the entire target frame in the horizontal direction includes making repeated passes in the horizontal direction at different vertical positions within the target frame; and
traversing the entire target frame in the vertical direction includes making repeated passes in the vertical direction at different horizontal positions within the target frame.

189. The method according to claim 188 wherein adjacent different vertical positions and adjacent different horizontal positions within the target frame differ by at most a predetermined number of rows of bits and predetermined number of columns of bits.

190. The method according to claim 189 wherein the predetermined number of rows of bits is one and the predetermined number of column of bits is one.

191. The method according to claim 188 wherein each of the steps of traversing is implemented using a different processor thread.

192. The method according to claim 191 wherein each of the steps of traversing is implemented using a plurality of different processor threads.

193. The method according to claim 159 wherein at least one video processor thread is used in the step of comparing to compare reference frame video data with target frame video data and at least one audio processor thread is used to compare reference frame audio data with target frame audio data.

194. The method according to claim 159 wherein at least one processor thread is used in the step of comparing to compare reference frame video data with target frame video data and also reference frame audio data with target frame audio data.

195. A method of compressing a bit-size of a plurality of sequential frames, each frame comprised of a plurality of bits, the method comprising the steps of:
comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing using a plurality of different threads for comparing, and the search blocks within each of the threads having a uniform size, such that the corresponding compared blocks also have the uniform size; and
using the plurality of compared blocks to obtain a representation of the target frame that is compressed from an original state, the step of using including the steps of:
determining whether adjacent compared blocks exist that can be compressed; and
for at least certain of the adjacent compared blocks that can be compressed, creating at least one superset block of non-uniform size that includes the certain adjacent compared blocks therein.

196. The method according to claim 195 wherein the certain adjacent compared blocks includes all certain adjacent compared blocks.

197. The method according to claim 195 wherein a plurality of superset block of non-uniform size are created, that each includes certain adjacent compared blocks therein, and wherein the certain adjacent compared blocks within each of the plurality of superset blocks are not adjacent to each other.

198. The method according to claim 195 wherein the certain adjacent compared blocks that can be compressed are represented using a linked list.

199. The method according to claim 195 wherein the certain adjacent compared blocks that can be compressed are represented using a binary tree.

200. A method of searching for patterns within a plurality of sequential frames, each frame comprised of a plurality of bits arranged in a matrix array, the method comprising:
comparing in a lossy manner a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing including:
obtaining, for a first search block, a first weight indicative of a percentage of comparisons that exist within the target frame;
obtaining, for a second search block that overlaps the first search block, a second weight indicative of another percentage of comparisons that exist within the target frame; and
if the first weight and the second weight both have a percentage of comparisons that exceed a determined threshold, discarding that compared block of the first and second search blocks that has a lower percentage of comparisons.

201. The method according to claim 200 wherein the compared blocks that can be compressed are represented using a linked list.

202. The method according to claim 200 wherein the compared blocks that can be compressed are represented using a binary tree.

203. The method according to claim 200 wherein the determined threshold is selectably adjustable.

204. A method of searching for patterns within a plurality of sequential frames, each frame comprised of a plurality of bits arranged in a matrix array, the method comprising:
comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing including:
initiating a predictive thread that compares a number of different predictive search blocks having different block sizes at various positions within the matrix array of the reference frame with various corresponding predictive target blocks in the target frame to obtain a predicted optimum block size and a predicted movement direction for the target frame; and
initiating a traversal of the target frame in a direction corresponding to the predicted movement direction with a search block having a size corresponding to the predicted optimum block size.

205. The method according to claim 204 wherein the predicted optimum block size is within a range of 8×8 bytes and 128×128 bytes.

206. The method according to claim 205 wherein the predicted movement direction is one of horizontal, vertical and diagonal.

207. The method according to claim 204 wherein the predicted movement direction is one of horizontal, vertical and diagonal.

208. The method according to claim 204 wherein the step of initiating the traversal initiates the traversal using a processor thread.

209. The method according to claim 204 wherein the step of initiating the traversal initiates the traversal using a plurality of processor threads, each processor thread traversing the target frame the predicted movement direction with the predicted optimum block size.

210. The method according to claim 209 further including the step of initiating further traversals of the target frame in another direction that does not correspond to the predicted movement direction.

211. The method according to claim 210 further including the step of terminating one of the initial traversals and the further traversals before that traversal is complete.

212. The method according to claim 210 wherein the step of terminating occurs when a predetermined number of matches of compared blocks is not reached after traversing the target frame with different search blocks representing a predetermined portion of the reference frame.

213. A method of searching for patterns within a plurality of sequential frames, each frame comprised of a plurality of bits arranged in a matrix array that can be traversed in at least horizontal and vertical directions, the method comprising the steps of:
comparing a plurality of different search blocks within a reference frame to a target frame to obtain a plurality of compared blocks, the reference frame being set to an initial frame of the plurality of sequential frames and the target frame initially being set to a subsequent frame of the plurality of sequential frames, the step of comparing including:
traversing the target frame in at least horizontal and vertical directions at increments that are greater than a single bit column or bit row, respectively, to compare search blocks to corresponding target blocks within the target frame, the step of traversing including, for those search blocks and corresponding target blocks at an edge of the matrix array, padding bit positions within the search blocks and corresponding target blocks that are outside of the reference frame and target frame, respectively, with identical information so that a size of the search block and the corresponding target block can be maintained for the entire step of traversing.

214. A method of searching for patterns comprising the steps of:
obtaining a plurality of sequential and time-related frames each comprised of a plurality of bits that represent video information and another plurality of bits that represent audio information;
comparing a plurality of different search blocks within a reference frame to a target frame to obtain a plurality of compared blocks, the reference frame initially being set to an initial frame of the plurality of sequential and time-related frames and the target frame initially being set to a subsequent frame of the plurality of sequential and time-related frames;
using the plurality of compared blocks to obtain a representation of the target frame that is compressed.

215. The method according to claim 214 further including the steps of repeating the steps redesignating and repeating so that each of the remaining plurality of sequential frames become the target frame one time while the steps of comparing and using are performed.

216. The method according to claim 214 wherein the step of obtaining further includes the step of placing a marker between the video information and the audio information within each of the plurality of sequential and time-related frames.

217. The method according to claim 214 wherein the representation of the target frame that is compressed uses a linked list.

218. The method according to claim 214 wherein the plurality of bits that represent the audio information represent the audio information using a color space and the step of comparing includes the steps of:
traversing the target frame, including both the video information and the audio information, in a horizontal direction to compare each of a first group of the plurality of different search blocks to different positions within the target frame; and
traversing the target frame, including both the video information and the audio information, in a vertical direction to compare each of a second group of the plurality of different search blocks to different positions within the target frame.

219. The method according to claim 218 wherein the step of comparing includes traversing the target frame in a diagonal direction, including both the video information and the audio information, to compare each of a third group of the plurality of different search blocks to different positions within the target frame.

220. The method according to claim 219 wherein the step of comparing further includes the step of traversing the target frame, including both the video information and the audio information, to compare each of a fourth group of the plurality of different search blocks to different positions within the target frame at different rotational positions.

221. The method according to claim 220 wherein the steps of traversing the first group, the second group, the third group and the fourth group are operated on in parallel operations.

222. The method according to claim 221 further including the step of terminating the step of traversing one of the first, second, third and fourth group before terminating the steps of traversing the others of the first, second, third and fourth group.

223. The method according to claim 221 wherein the step of comparing compares search blocks with target blocks within the target frame, and further including the step of terminating specific ones of the search blocks used by the steps of traversing the first, second, third and fourth groups if, after a predetermined portion of the target frame is compared, a predetermined number matches between the one search block and the corresponding target blocks is not reached.

224. The method according to claim 223 wherein the predetermined number is one.

225. The method according to claim 223 wherein the matches are required to be identical matches.

226. The method according to claim 223 wherein the matches can introduce loss.

227. The method according to claim 221 the step of comparing compares search blocks with target blocks within the target frame, and further including the step of terminating specific ones of the search blocks used by the steps of traversing the first, second, third and fourth groups if, after a predetermined portion of the target frame is compared, other ones of the search blocks result in a predetermined greater percentage of matches between the one search block and the corresponding target blocks.

228. The method according to claim 219 wherein the steps of traversing the first group, the second group, the third group are operated on in parallel operations.

229. The method according to claim 228 further including the step of terminating the step of traversing one of the first, second and third group before terminating the steps of traversing the others of the first, second and third group.

230. The method according to claim 228 wherein the step of comparing compares search blocks with target blocks within the target frame, and further including the step of terminating specific ones of the search blocks used by the steps of traversing the first, second and third groups if, after a predetermined portion of the target frame is compared, a predetermined number matches between the one search block and the corresponding target blocks is not reached.

231. The method according to claim 230 wherein the predetermined number is one.

232. The method according to claim 230 wherein the matches are required to be identical matches.

233. The method according to claim 230 wherein the matches can introduce loss.

234. The method according to claim 228 the step of comparing compares search blocks with target blocks within the target frame, and further including the step of terminating specific ones of the search blocks used by the steps of traversing the first, second and third groups if, after a predetermined portion of the target frame is compared, other ones of the search blocks result in a predetermined greater percentage of matches between the one search block and the corresponding target blocks.

235. The method according to claim 218 wherein the steps of traversing the first group and the second group are operated on in parallel operations.

236. The method according to claim 235 further including the step of terminating the step of traversing one of the first and second group before terminating the steps of traversing the others of the first and second group.

237. The method according to claim 235 wherein the step of comparing compares search blocks with target blocks within the target frame, and further including the step of terminating specific ones of the search blocks used by the steps of traversing the first and second groups if, after a predetermined portion of the target frame is compared, a predetermined number matches between the one search block and the corresponding target blocks is not reached.

238. The method according to claim 237 wherein the predetermined number is one.

239. The method according to claim 237 wherein the matches are required to be identical matches.

240. The method according to claim 237 wherein the matches can introduce loss.

241. The method according to claim 235 the step of comparing compares search blocks with target blocks within the target frame, and further including the step of terminating specific ones of the search blocks used by the steps of traversing the first and second groups if, after a predetermined portion of the target frame is compared, other ones of the search blocks result in a predetermined greater percentage of matches between the one search block and the corresponding target blocks.

242. The method according to claim 218 wherein the steps of traversing traverse the target frame such that sequential different positions within the target frame overlap one another.

243. The method according to claim 242 wherein the sequential different positions differ by at most a predetermined number of rows of bits and predetermined number of columns of bits.

244. The method according to claim 243 wherein the predetermined number of rows of bits is one and the predetermined number of column of bits is one.

245. The method according to claim 218 wherein at least one of the steps of traversing the target frame in the horizontal direction and traversing the target frame in the vertical direction traverses the entire target frame.

246. The method according to claim 245 wherein:
traversing the entire target frame in the horizontal direction includes making repeated passes in the horizontal direction at different vertical positions within the target frame; and
traversing the entire target frame in the vertical direction includes making repeated passes in the vertical direction at different horizontal positions within the target frame.

247. The method according to claim 246 wherein adjacent different vertical positions and adjacent different horizontal positions within the target frame differ by at most a predetermined number of rows of bits and predetermined number of columns of bits.

248. The method according to claim 247 wherein the predetermined number of rows of bits is one and the predetermined number of column of bits is one.

249. The method according to claim 246 wherein each of the steps of traversing is implemented using a different processor thread.

250. The method according to claim 249 wherein each of the steps of traversing is implemented using a plurality of different processor threads.

251. The method according to claim 214 wherein at least one video processor thread is used in the step of comparing to compare reference frame video data with target frame video data and at least one audio processor thread is used to compare reference frame audio data with target frame audio data.

252. The method according to claim 214 wherein at least one processor thread is used in the step of comparing to compare reference frame video data with target frame video data and also reference frame audio data with target frame audio data.

253. The method according to claim 214 wherein the step of using obtains the representation of the target frame that is compressed as compared to the original state without any loss being introduced.

254. The method according to claim 214 wherein the step of comparing compares the search block with the target frame using AND operations.

255. The method according to claim 214 wherein the step of using obtains the representation of the target frame that is compressed as compared to the original state with loss being introduced.

256. The method according to claim 255 wherein the step of comparing compares the search block with the target frame using AND operations.

257. The method according to claim 255 wherein the step of comparing compares the search block with the target frame using OR operations.

258. The method according to claim 255 wherein the step of comparing compares the search block with the target frame using XOR operations.

259. The method according to claim 255 wherein the step of comparing compares the search block with the target frame using add operations.

260. The method according to claim 255 wherein the step of comparing compares the search block with the target frame using subtract operations.

261. The method according to claim 255 wherein the step of comparing compares the search block with the target frame using multiply operations.

262. The method according to claim 255 wherein the step of comparing compares the search block with the target frame using divide operations.

263. The method according to claim 214 wherein the step of using combines overlapping ones of the plurality of compared blocks to obtain a superset block that is used for the representation.

264. The method according to claim 214 wherein the step of comparing includes the step of tracking compared blocks that represent an identical match between the search block and a corresponding target block that exists within the target frame.

265. The method according to claim 264 wherein step of tracking is used to provide a dynamic indication of an amount of compression achievable between the reference frame and the target frame and wherein the step of comparing further includes the step of selecting a compression target ratio.

266. The method according to claim 264 wherein the step of comparing is stopped when the dynamic indication indicates that the compression target ratio is reached for the target frame.

267. The method according to claim 266 wherein the step of comparing further includes the step of selecting a desired amount of loss that can be tolerated within the representation.

268. The method according to claim 267 wherein the compared block is considered identical to the search block if a percentage of bits within the target block is at least equal to the desired amount of loss.

269. The method according to claim 214 wherein the step of comparing further includes the step of selecting an amount of loss that can be tolerated within the representation.

270. The method according to claim 214 wherein the step of comparing includes the steps of:
initiating a predictive processor thread to obtain an estimate of a likelihood of matches between the search block and the target frame; and
passing the estimate on to at least one comparing processor thread that is used to compare the plurality of different search blocks within the reference frame to the target frame to obtain the plurality of compared blocks.

271. The method according to claim 214 wherein the step of comparing compares at a bit level.

272. The method according to claim 214 wherein the step of comparing compares at a byte level.

273. A method of compressing a bit-size of a plurality of sequential frames, each frame comprised of a plurality of bits, the method comprising the steps of:
comparing a plurality of different search blocks within a reference frame to a target frame to obtain a plurality of compared blocks, the reference frame initially being set to an initial frame and the target frame initially being set to a subsequent frame, the step of comparing including the steps of:
determining whether a desired compression ratio between the reference frame and the subsequent frame is reached;
if the desired compression ratio is reached, then terminating the step of comparing; and
if the desired compression ration is not reached, then using the plurality of compared blocks to obtain a representation of the target frame that is compressed as compared to an original state.

274. The method according to claim 273 further including the steps of:
redesignating as the reference frame the subsequent frame that was the target frame and redesignating as the target frame another subsequent frame that follows the subsequent frame; and
repeating the steps of comparing and determining.

275. An apparatus for pattern recognition on a plurality of sequential frames, each frame comprised of a plurality of bits, the apparatus comprising:
a processor which uses an application program to initiate a predictive thread to determine a default pattern direction, make comparisons between various search blocks from a reference frame with corresponding target search areas of a target frame in at least horizontal and vertical directions using a different thread for each direction, obtain comparison matches as a linked list, process the linked list to obtain a superset block that includes overlapping comparison matches, and store a resulting compressed frame; and
a memory for storing the resulting compressed frame.

276. A computer readable medium operable with a processor comprising:
a computer program stored on the computer readable medium operable to perform pattern recognition that initiates a predictive thread to determine a default pattern direction, makes comparisons between various search blocks from a reference frame with corresponding target search areas of a target frame in at least horizontal and vertical directions using a different thread for each direction, obtains comparison matches as a linked list, process the linked list to obtain a superset block that includes overlapping comparison matches, and stores a resulting compressed frame.
